(19) United States
(12) Patent Application Publication
(10) Pub. No.: US 2005/0168410 A1
(43) Pub. Date: Aug. 4, 2005

(54) Drive circuit and drive method

(75) Inventors: Shigetoshi Tomio, Kawasaki (JP); Tomokatsu Kishi, Kawasaki (JP); Katsumi Itoh, Kawasaki (JP); Tetsuya Sakamoto, Kawasaki (JP); Fumitaka Asami, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, Kawasaki (JP)

(21) Appl. No.: 11/096,102

(22) Filed: Apr. 1, 2005

Related U.S. Application Data
(63) Continuation of application No. PCT/JP03/11482, filed on Sep. 9, 2003.

(30) Foreign Application Priority Data
Oct. 2, 2002 (JP) 2002-290535

(51) Int. Cl. G09G 3/28

(52) U.S. Cl. 345/60

(57) ABSTRACT

A first signal line (OUTA) supplies a first electric potential to a terminal of an X-side of a load (20) through a switch (SW4). A second signal line (OUTB) supplies a second electric potential to the terminal of the X-side of the load (20) through a switch (SW5). Coil circuits (A and B) are connected between the first signal line (OUTA) and the second signal line (OUTB) and a ground. Furthermore, each of the coil circuits (A and B) is a circuit configured with, for example, a coil and a diode, and the coil is connected so as to carry out L-C resonance with the load (20) through the switches (SW4 and SW5).

### TECHNICAL FIELD

The present invention relates to a drive circuit and a drive method of a flat-surface type panel display device including a capacitive load panel and, more specifically, to a drive circuit and a drive method of plasma display EL (Electroluminescence).

### BACKGROUND ART

Conventionally, one of plasma display devices, AC-Plasma Display Panel (AC-PDP), is classified into two types: a 2-electrode type conducting selective discharge (address discharge) and sustaining discharge by two electrodes (a first electrode and a second electrode); and a 3-electrode type conducting address discharge using a third electrode. The above 3-electrode type has two types in its structure: one is a type that has the third electrode being formed on a same side of the substrate where the first electrode and the second electrode which conduct sustaining discharge are placed; and the other is a type that has the third electrode being formed on another substrate facing thereto.

Since the respective PDP devices described above are based on a same principle of operation, an example of the structure of the PDP devices with the first electrode and the second electrode being formed on a first substrate and with the third electrode being formed on a second substrate facing to the first substrate is explained below.

FIG. 15 is a diagram showing an overall structure of an AC-PDP device. The AC-PDP device 1 shown in FIG. 15 has a panel P including plural cells, each of which represents one pixel of a display image and is arranged in a matrix pattern. Specifically, the respective cells are cells Cmn arranged in a matrix with m rows and n columns, as shown in FIG. 15. Additionally, in the AC-PDP device 1, scan electrodes Y1 to Yn and common electrodes X are installed in parallel to each other on the first substrate, and address electrodes A1 to Am are installed perpendicular to these electrodes Y1 to Yn and common electrodes X on the second substrate opposite to the first substrate. Each common electrode X is installed close to its corresponding one of the scanning electrodes Y1 to Yn, and the common electrodes X are commonly connected to one terminal thereof.

A common terminal of the common electrodes X is connected to an output terminal of an X-side circuit 2, and the scanning electrodes Y1 to Yn are respectively connected to output terminals of a Y-side circuit 3. The address electrodes A1 to Am are connected to output terminals of an address-side circuit 4. The X-side circuit 2 includes a circuit for repeating discharge. The Y-side circuit 3 includes a circuit for line-sequential scanning and a circuit for repeating discharge. The address-side circuit 4 includes a circuit for selecting a column to display.

These X-side circuit 2, Y-side circuit 3, and address-side circuit 4 are controlled by control signals supplied from a drive control circuit 5. Namely, the address-side circuit 4 and the circuit which conducts line-sequential scanning in the Y-side circuit 3 determine which cell to be lighted. Then the X-side circuit 2 and the Y-side circuit 3 repeat discharge to carry out a display operation of the PDP device.

The drive control circuit 5 generates the control signals based on a display data D, a clock CLK which indicates timing to read the display data D, a horizontal synchronization signal HS, and a vertical synchronization signal VS, all being supplied externally. Then these control signals will be supplied to the X-side circuit 2, the Y-side circuit 3, and the address-side circuit 4. Based on the abovementioned structure, the AC-PDP device 1 can produce an image on the panel P by controlling blinks of the respective cells.

A structure of the respective cells of the AC-PDP device 1 shown in FIG. 15 is explained hereinafter. FIG. 16A is a diagram showing the structure of the cells equipped in the AC-PDP device 1 shown in FIG. 15. FIG. 16A is a diagram showing a cross sectional structure of a cell Cij as one pixel, which is in an i-th row and a j-th column. In FIG. 16A, a common electrode X and a scan electrode Y1 are formed on a front glass substrate 11. A dielectric layer 12 is deposited thereon as insulation against a discharge space 17. Further, an MgO (magnesium oxide) protective film 13 is deposited thereon.

On the other hand, an address electrode Aj is formed on a rear glass substrate 14 displaced opposite to the front glass substrate 11. A dielectric layer 15 is deposited thereon, and further, a phosphor 18 is deposited thereon. An Ne+Xe penning gas or the like is enclosed in the discharge space 17 between the MgO protective film 13 and the dielectric layer 15.

FIG. 16B is a diagram for describing a capacity Cp of the AC-PDP device. As shown in FIG. 16B, in the AC-PDP device, capacitive components Ca, Cb, and Cc exist in the discharge space 17, between the common electrode X and the scan electrode Y, and on the front glass substrate 11, respectively. A capacitance Cpcell per one cell is defined (Cpcell=Ca+Cb+Cc) by a sum of these capacitive components. A sum of the capacitance Cpcell of every cell defines a panel capacitance Cp.

FIG. 16C is a diagram for describing an emission of fluorescence of the AC-PDP device. As can be seen in FIG. 16C, phosphors 18 of red, blue and green are respectively arranged to be in a stripe form and applied on inside surfaces of ribs 16. The phosphor 18 emits fluorescence when it is excited by discharge between the common electrode X and the scan electrode Y.

Next, an operation of the AC-PDP device 1 shown in FIG. 15 is explained with the use of a waveform chart.

FIG. 17 is the waveform chart showing the operation of the AC-PDP device 1 shown in FIG. 15. FIG. 17 shows examples of waveforms of voltages applied to an X-electrode, a Y-electrode, and an address electrode in one sub-field among plural sub-fields which compose one frame. One sub-field is divided into a reset period which includes a total write period and a total erasing period, an address period, and a sustaining discharge period.

During the reset period, a voltage applied to the common electrode X is caused to decrease from a ground level to (−Vs/2). On the other hand, a sum of a voltage Vw and a voltage (Vs/2) is applied to a voltage which is applied to the scan electrode Y. At this time, the voltage (Vs/2+Vw) gradually increases as time passes. As a result, a potential difference between the common electrode X and the scan electrode Y becomes (Vs+Vw), causing discharge on all cells of all display lines regardless of a prior display status, thereby forming wall charges (total write).

Next, after the voltages of the common electrode X and the scan electrode Y are returned to the ground level, an applied voltage to the common electrode X is caused to increase from the ground level to the voltage (Vs/2), while the applied voltage to the scan electrode Y is caused to decrease to the voltage (−Vs/2). Accordingly, the voltages of their wall charges of all cells reach and exceed a firing potential to thereby start discharge. At this time, by the applied voltage to the common electrode X as mentioned above, the stored wall charges are erased (total erase).

Next, during the address period, line-sequential address discharge is conducted in order to turn on and/or off each cell according to display data. At this time, a voltage (Vs/2) is applied to the common electrode X. When applying a voltage to a scan electrode Y which corresponds to one display line, a negative voltage (−Vs/2) is applied to the scan electrodes Y which are line-sequentially selected, and a ground level voltage is applied to the scan electrodes Y which are not line-sequentially selected.

At this time, address pulses of a voltage Va are selectively applied to address electrodes Aj between the address electrodes A1 and Am, corresponding to cells which conduct sustaining discharge, i.e., cells to be lighted. Then discharges occur between the address electrodes Aj of the cells to be lighted and the line-sequentially selected scan electrodes Y. Using these discharges as priming, other discharges immediately start between the common electrodes X and the scan electrodes Y. At the same time, an amount of the wall charges enough for next sustaining discharges is stored in the MgO protective film above the common electrodes X and the scan electrodes Y of the selected cells.

Thereafter, during the sustaining discharge period, the voltage of the common electrode X gradually increases due to influence of a power recovery circuit described later. Then, the voltage of the common electrode X is clamped to (Vs/2) before reaching a voltage at its most increased point.

Thereafter, the voltage of the scan electrode Y gradually decreases. At the same time, a part of an electric charge is recovered to the power recovery circuit. Note that an operation of the power recovery circuit is described later. The voltage of the scan electrode Y is clamped to (−Vs/2) before reaching a voltage at its most decreased point. Similarly, when the applied voltages of the common electrode X and the scan electrode Y increase from voltage (−Vs/2) to the ground level (0(zero) V), the applied voltages are caused to gradually increase. Furthermore, the voltage (Vs/2+Vx) is applied to the scan electrode Y only during a period when high-voltage is applied for a first time. Incidentally, a voltage Vx is an additional voltage which generates a voltage required for sustaining discharge by adding to voltages of the wall charges generated during the address period shown in FIG. 17.

On the other hand, when the applied voltages of the common electrode X and the scan electrode Y decrease from voltage (Vs/2) to the ground level (0(zero) V), the applied voltages are caused to decrease gradually, and a part of the electric charge stored in the cell is recovered to the power recovery circuit.

During the sustaining discharge period, the voltages (+Vs/2, −Vs/2) having different polarities are alternately applied to the common electrodes X and the scan electrodes Y of the respective display lines to conduct sustaining discharge; thereby an image of one sub-field is displayed. Incidentally, the alternately applying operation is called a sustain operation, and a detailed explanation of this operation is given by using FIG. 19 to be described later.

Note that, each cell of the AC-PDP device 1 has the capacitive components existing in the discharge space of each cell, between the common electrode X and the scan electrode Y, and on the front glass substrate, respectively. The capacitance per one cell is defined by the sum of these capacitive components. Furthermore, on an inner surface of the each cell of the AC-PDP device 1, the phosphors of red, blue and green are respectively arranged to be in a stripe form and applied, and the phosphor emits the fluorescence when it is excited by discharge between the common electrode X and the scan electrode Y.

However, the aforementioned X-side circuit 2 and Y-side circuit 3 (hereinafter referred to as drive circuits) are circuits for outputting high voltage signals in order to discharge within the cell; therefore, each element which composes the drive circuit requires high withstand voltage and it is a factor for increasing a manufacturing cost. Accordingly, a technology for attempting simplification of circuitry and reduction of the manufacturing cost is proposed by lowering the withstand voltage of each element equipped in the abovementioned drive circuit. For example, suggested is the drive circuit which conducts discharge between electrodes utilizing a potential difference between electrodes produced by applying a positive voltage to one electrode and a negative voltage to the other (for example, Patent Document 1.).

A schematic configuration and an operation of the aforementioned drive circuit are explained hereinafter.

FIG. 18 is a diagram showing the schematic configuration of the drive circuit of the AC-PDP device 1 shown in FIG. 15. (However, only the X-side circuit 2 is explained. The Y-side circuit 3 has the same configuration and operation as the X-side circuit 2 does; and therefore, an explanation thereof is omitted.)

In FIG. 18, a capacitive load 20 (hereinafter, referred to as a “load 20”) is a sum of capacitance of a cell Cmn being formed between one common electrode X and one scan electrode Y. The common electrode X and the scan electrode Y are formed on the load 20. Here, a scan electrode Y is any scan electrode among the plural scan electrodes Y1 to Yn.

First, on the common electrode X side, switches SW1 and SW2 are connected serially between a power supply line (a power line) of voltage (Vs/2) supplied from a power supply and a ground (GND). A node between the two switches SW1 and SW2 is connected to one terminal of a capacitor C1, and a switch SW3 is connected between the other terminal of the capacitor C1 and the ground. Note that a signal line connected to one terminal of the capacitor C1 is a first signal line OUTA, and that a signal line connected to the other terminal thereof is a second signal line OUTB.

Switches SW4 and SW5 are connected serially to the both terminals of the capacitor C1. Then a node between these two switches SW4 and SW5 is connected to the common electrode X of the load 20 through an output line OUTC and further connected to a power recovery circuit 21. The power recovery circuit 21 includes two coils L1 and L2 which are both connected to the load 20, a switch SW6 connected serially to one coil L1, and a switch SW7 connected serially to the other coil L2. Furthermore, the power recovery circuit 21 includes a capacitor C2 connected between a node of the aforementioned two switches SW6 and SW7, and the second signal line OUTB.

Then two systems of series resonant circuits are configured with the aforementioned capacitive load 20 and the coils L1 and L2 both connected thereto. In other words, this power recovery circuit 21 has two systems of L-C resonant circuits supplying an electric charge to the panel P by resonance between the coil L1 and the load 20, and recovering the electric charge by resonance between the coil L2 and the load 20.

The aforementioned switches SW1 to SW7 are controlled by control signals respectively supplied from the drive control circuit 5 shown in FIG. 15. As described above, the drive control circuit 5 is configured using a logic circuit or the like, and it generates the control signals based on the display data D, the clock CLK, the horizontal synchronization signal HS, and the vertical synchronization signal VS, all being supplied externally. Then, these control signals are supplied to the switches SW1 to SW7. Incidentally, as described above, a period when the common electrode X and the scan electrode Y in the cell discharge is called a sustaining discharge period.

FIG. 19 is a time chart showing drive waveforms of the drive circuit of the AC-PDP device 1 as configured in FIG. 18 during the sustaining discharge period.

During the sustaining discharge period, on the common electrode X side, the switches SW1, SW3, and SW5 are firstly turned on, and the rest of the switches SW2, SW4, SW6, and SW7 are turned off. At this time, a voltage (a first electric potential) of the first signal line OUTA becomes (+Vs/2). Voltages (a second electric potential) of the second signal line OUTB and the output line OUTC are on a ground level (t1).

By turning on the switch SW6 in the power recovery circuit 21, L-C resonance is carried out between the coil 1 and the capacitance of the load 20. An electric charge recovered in the capacitor C2 is supplied to the load 20 through the switch SW6 and the coil L1 (t2). By this electric current flow, the voltage of the output line OUTC applied to the common electrode X gradually increases as shown in time between t2 and t3 in FIG. 19. Additionally, the switch SW5 is turned off at the time t2.

Next, by turning on the switch SW4 before reaching a peak voltage appearing in this resonance, the voltage of the output line OUTC applied to the common electrode X is clamped to (Vs/2) (t3). Additionally, the switch SW6 is turned off at the time t3.

When the voltage of the output line OUTC applied to the common electrode X is caused to decrease from the voltage (Vs/2) to the ground level (0(zero) V), the switch SW7 is turned on and the switch SW4 is turned off (t4). This carries out L-C resonance between the coil 2 and the capacitance of the load 20. The part of the electric charge stored in the load 20 is recovered to the capacitor C2 in the power recovery circuit 21 through the coil L2 and the switch SW7. By this electric current flow, the voltage of the output line OUTC applied to the common electrode X gradually decreases as shown in time between t4 and t5 in FIG. 19.

Next, by turning on the switch SW5 before reaching a peak voltage (a peak voltage in a negative direction) appearing in this resonance, the voltage of the output line OUTC applied to the common electrode X is clamped to (−Vs/2) (t5). Additionally, the switch SW7 is turned off at the time t5.

The switches SW1, SW3 and SW5 are turned off, and the switches SW2 and SW4 are turned on. At this time, the switches SW6 and SW7 are kept off. At this time, the voltage of the first signal line OUTA decreases to the ground level. The voltages of the second signal line OUTB and the output line OUTC turn to (−Vs/2) (t6).

By turning on the switch SW7 in the power recovery circuit 21, L-C resonance is carried out between the coil 2 and the capacitance of the load 20. The electric charge (a negative side) recovered in the capacitor C2 is supplied to the load 20 through the switch SW7 and the coil L2 (t7). By this electric current flow, the voltage of the output line OUTC applied to the common electrode X gradually decreases as shown in time between t7 and t8 in FIG. 19. Additionally, the switch SW4 is turned off at the time t7.

Next, by turning on the switch SW5 before reaching a peak voltage (a peak voltage in a negative direction) appearing in this resonance, the voltage of the output line OUTC applied to the common electrode X is clamped to (−Vs/2) (t8). Additionally, the switch SW7 is turned off at the time t8.

When the voltage of the output line OUTC applied to the common electrode X is caused to decrease from the voltage (Vs/2) to the ground level (0(zero) V), the switch SW6 is firstly turned on and the switch SW5 is turned off (t9). This carries out L-C resonance between the coil L1 and the capacitance of the load 20. The part of the electric charge stored in the load 20 is recovered to the capacitor C2 in the power recovery circuit 21 through the coil L1 and the switch SW6. By this electric current flow, the voltage of the output line OUTC applied to the common electrode X gradually increases as shown in time between t9 and t10 in FIG. 19.

Next, by turning on the switch SW4 before reaching a peak voltage appearing in this resonance, the voltage of the output line OUTC applied to the common electrode X is clamped to the ground level (t10). Additionally, the switch SW6 is turned off at the time t10. By the operation described above, the drive circuit shown in FIG. 18 applies a voltage changing from −Vs/2 to Vs/2 to the common electrode X during the sustaining discharge period. The voltages (+Vs/2, −Vs/2) having different polarities from the voltage supplied to the common electrodes X are alternately applied to the scan electrodes Y of the respective display lines. The AC-PDP device 1 conducts sustaining discharge by the above-mentioned method.

Incidentally, during the sustaining discharge period, wall charges having different polarities enough for sustaining discharge is stored in a protective film on the common electrode X and the scan electrode Y. Furthermore, when discharge is carried out between the common electrode X and the scan electrode Y, the wall charges between the common electrode X and the scan electrode Y in the cell become the wall charges having opposite polarities up to then, thereby discharge is converged. At this time, a time for moving the wall charges is required, and this time is defined by the time that the voltage +Vs/2 or the voltage −Vs/2 is applied to the common electrode X.

Related arts are described in:
Patent Document 1: Japanese Patent Application Laid-open No. 2002-062844;
Patent Document 2: Japanese Patent Application Laid-open No. Hei 09-325735;
Patent Document 3: U.S. Pat. No. 3,559,190;
Patent Document 4: U.S. Pat. No. 4,707,692;
Patent Document 5: U.S. Pat. No. 3,626,244;
Patent Document 6: Japanese Patent Application Laid-open No. Shou 51-71730;
Patent Document 7: U.S. Pat. No. 4,070,663;
Patent Document 8: Japanese Patent Publication No. Shou 58-53344;
Patent Document 9: U.S. Pat. No. 3,780,339;
Patent Document 10: U.S. Pat. No. 4,866,349;
Patent Document 11: U.S. Pat. No. 5,081,400;
Nonpatent Document 1: Marvin L. Higgins, “A Low-Power Drive Scheme for AC TFEL Displays”, SID 85 Digest, U.S.A., 1985, pp. 226-228; and
Nonpatent Document 2: Marvin L. Higgins, “High-Quality Electroluminescent Display for a Personal Workstation”, HEWLETT-PACKARD Journal, U.S.A., October 1985, pp. 12-17.

However, there is a problem that control timing for controlling the respective switches is complicated because there are many numbers of switches such as SW1 to SW7 in a driving system of the aforementioned AC-PDP device 1.

The drive control circuit 5 configured with logic circuits or the like has a reference potential of the ground level. Power elements to which control signals are supplied from the drive control circuit 5 so as to apply voltage to the common electrode X and the scan electrode Y, that are switches SW4, SW5, and the switches SW6 and SW7 in the power recovery circuit 21, change their reference potentials according to a driving operation. Accordingly, for example, when the drive control circuit 5 generates the signals and supplies them to the power elements, electrical separation and level shift are required in order to prevent a back flow of a voltage variation from the power elements to the drive control circuit 5. There is a problem that a circuit or an element for this purpose is further required so that the number of parts or cost of parts increases.

Furthermore, as shown in FIG. 19, for example, during the time between t5 and t7, there exists a period T in which the voltage of the output line OUTC applied to the common electrode X according to related arts becomes the ground level. This period T is generated in order to take a margin for timing of change of signals of SW1 to SW7. Therefore, there is a demand for shortening the aforementioned period T in order to secure a period (a period when a voltage applied to the common electrode X is Vs/2 or −Vs/2) when the wall charges in the cell completely move, within as short a period as possible.

Furthermore, as shown in FIG. 18, the power recovery circuit 21 includes the capacitor C2. However, the voltage charged in the capacitor C2 is required to be supervised in order to protect the circuits under an abnormal operating time; therefore, a circuit for this purpose is required. Accordingly, there is a demand for realizing a power recovery circuit 21 without the capacitor C2. In other words, there is a demand for eliminating a circuit for a purpose of voltage supervision that has become unnecessary due to elimination of the capacitor C2.

The present invention is made to solve the aforementioned circumstances, and an object thereof is to provide a drive circuit having decreased number of switches compared with related arts and a drive method thereof.

An object of the present invention is to provide the drive circuit and the drive method, the drive circuit having reduced number of elements influenced by high-voltage of a power element or change of a reference potential is decreased compared with the related arts.

An object of the present invention is to provide the drive circuit and the drive method, the drive circuit being enabled to shorten a period of the aforementioned ground level on a voltage waveform applied to a common electrode X.

An object of the present invention is to provide the drive circuit and the drive method in which a capacitor used in a conventional power recovery circuit is omitted.

### SUMMARY OF THE INVENTION

The present invention is made to solve the aforementioned problems, and the drive circuit according to the present invention is a drive circuit of a matrix-type flat panel display device for applying voltage to a capacitive load being a display cell, and the drive circuit comprises a first signal line supplying a first electric potential to one terminal of the capacitive load, a second signal line supplying a second electric potential different from the first electric potential to one terminal of the capacitive load, and a coil circuit connected between at least either the first signal line or the second signal line and a ground. The coil circuit is a circuit configured with, for example, a coil and a diode, and the coil is connected so as to carry out L-C resonance with the capacitive load through a switch. Note that the switch is a switch to be inserted between the first signal line and the capacitive load, and a switch to be inserted between the second signal line and the capacitive load. Accordingly, the coil circuit comprises a charge function for supplying an electric charge to the capacitive load, and a discharge function for emitting the electric charge to the capacitive load by L-C resonance between the coil circuit and the capacitive load. A power recovery operation is realized by the charge function and the discharge function described above.

According to the drive circuit of the present invention configured as above, the coil circuit does not include a switch; therefore, the number of parts can be decreased compared with the related arts. Furthermore, a circuit for filling a difference of a signal level between a control signal for controlling the switch and a high-voltage signal of the power element is not required. A capacitor is not required for the power recovery circuit. Additionally, time required for processing of switching an electric potential of the power element can be shortened.

### BRIEF DESCRIPTION OF THE DRAWINGS

FIG. 1 is a diagram showing an example of a schematic configuration of a drive circuit of an AC-PDP device based on a first embodiment.

FIG. 2 is a diagram showing a schematic configuration of the drive circuit in which coil circuits A and B shown in FIG. 1 are specifically illustrated.

FIG. 3 is a waveform chart showing an operation of the drive circuit described in FIG. 2.

FIG. 4 is a diagram showing a specific circuit example of the drive circuit described in FIG. 2.

FIG. 5 is a diagram showing a schematic configuration of the drive circuit in which the coil circuits A and B shown in FIG. 1 are specifically illustrated.

FIG. 6 is a diagram showing a schematic configuration of the drive circuit in which the coil circuits A and B shown in FIG. 1 are specifically illustrated.

FIG. 7 is a waveform chart showing an operation of the drive circuit described in FIG. 6.

FIG. 8 is a diagram showing a schematic configuration of the drive circuit in which the coil circuits A and B shown in FIG. 1 are specifically illustrated.

FIG. 9 is a waveform chart showing an operation of the drive circuit described in FIG. 8.

FIG. 10 is a diagram showing a schematic configuration of a drive circuit of a second embodiment.

FIG. 11 is a waveform chart showing an operation of the drive circuit described in FIG. 10.

FIG. 12 is a diagram showing a schematic configuration of a drive circuit of a third embodiment.

FIG. 13 is a waveform chart showing an operation of the drive circuit described in FIG. 12.

FIG. 14 is a diagram showing a schematic configuration example of a drive circuit of a fourth embodiment.

FIG. 15 is a diagram showing an overall structure of an AC-PDP device.

FIG. 16A is a diagram showing a cross sectional structure of a cell Cij at row i and column j as one pixel in the AC-PDP device.

FIG. 16B is a diagram for explaining a capacitance of the AC-PDP device.

FIG. 16C is a diagram for explaining an emission of fluorescence of the AC-PDP device.

FIG. 17 is a waveform chart showing an operation of the AC-PDP device 1 described in FIG. 15.

FIG. 18 is a diagram showing a schematic configuration of a drive circuit of the AC-PDP device 1 described in FIG. 15.

FIG. 19 is a time chart showing drive waveforms of the drive circuit of the AC-PDP device 1 as configured in FIG. 18 during a sustaining discharge period.

FIG. 20 shows a schematic configuration of a drive circuit according to a fifth embodiment, which is a modification of the drive circuit according to the third embodiment shown in FIG. 12.

FIG. 21 is a waveform chart showing an operation of the drive circuit shown in FIG. 20.

FIG. 22 shows a schematic configuration of a drive circuit according to a sixth embodiment, which is a modification of the drive circuit according to the third embodiment shown in FIG. 12.

FIG. 23 is a waveform chart showing an operation of the drive circuit shown in FIG. 22.

FIG. 24 shows a schematic configuration of a drive-circuit according to a seventh embodiment, which is a modification of the drive circuit according to the second embodiment shown in FIG. 10.

FIG. 25 is a waveform chart showing an operation of the drive circuit shown in FIG. 24.

FIG. 26 shows a schematic configuration of a drive circuit according to an eighth embodiment, which is a modification of the drive circuit according to the second embodiment shown in FIG. 10.

FIG. 27 is a waveform chart showing an operation of the drive circuit shown in FIG. 26.

FIG. 28 shows a modification of the drive circuit according to the first embodiment shown in FIG. 2.

FIG. 29 is a waveform chart showing an operation of the drive circuit shown in FIG. 28 when a relationship in inductance between coils LA1 and LB1 is LA1>LB1.

FIG. 30 is a waveform chart showing an operation of the drive circuit shown in FIG. 28 when a relationship in inductance between coils LA1 and LB1 is LA1<LB1.

FIG. 31 shows a modification of the specific circuit (including the scan electrode Y side) of the drive circuit of FIG. 2 shown in FIG. 4.

FIG. 32 shows another modification of the specific circuit (including the scan electrode Y side) of the drive circuit of FIG. 2 shown in FIG. 4.

FIG. 33 shows an example of a more specific configuration of switches SW4′ and SW5′ and a load 20 in the specific drive circuit shown in FIG. 31.

FIG. 34 shows a modification of the specific circuit shown in FIG. 33.

FIG. 35 shows a schematic configuration of a drive circuit according to a ninth embodiment, which is a modification of the drive circuit according to the first embodiment shown in FIG. 4.

FIG. 36 is a waveform chart showing an operation of the drive circuit shown in FIG. 35.

FIG. 37 shows a modification of the drive circuit according to the ninth embodiment shown in FIG. 35.

FIG. 38 is a waveform chart showing an operation of the drive circuit shown in FIG. 37.

### DETAILED DESCRIPTION OF THE PREFERRED EMBODIMENTS

As one example of a display device with drive circuits representing one embodiment of the present invention, a plasma display panel, an embodiment of an AC-PDP device, is explained with reference to the drawings.

### First Embodiment

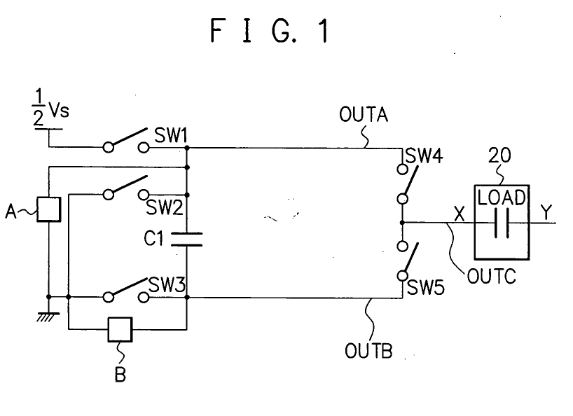

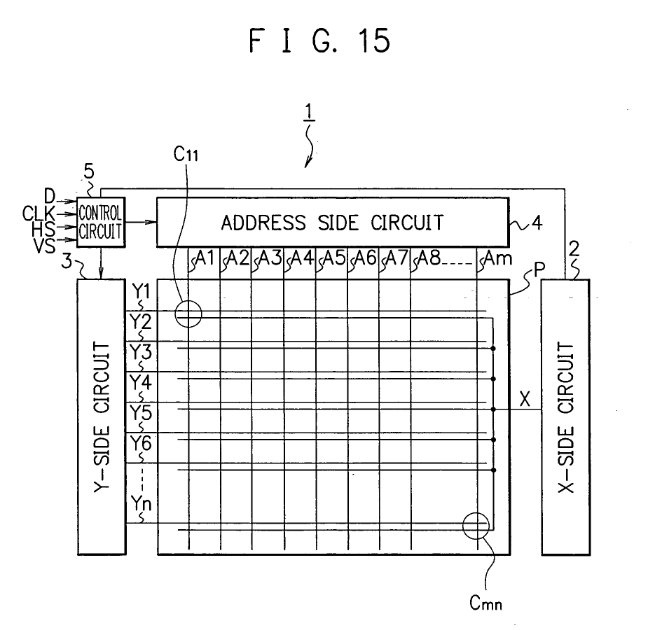

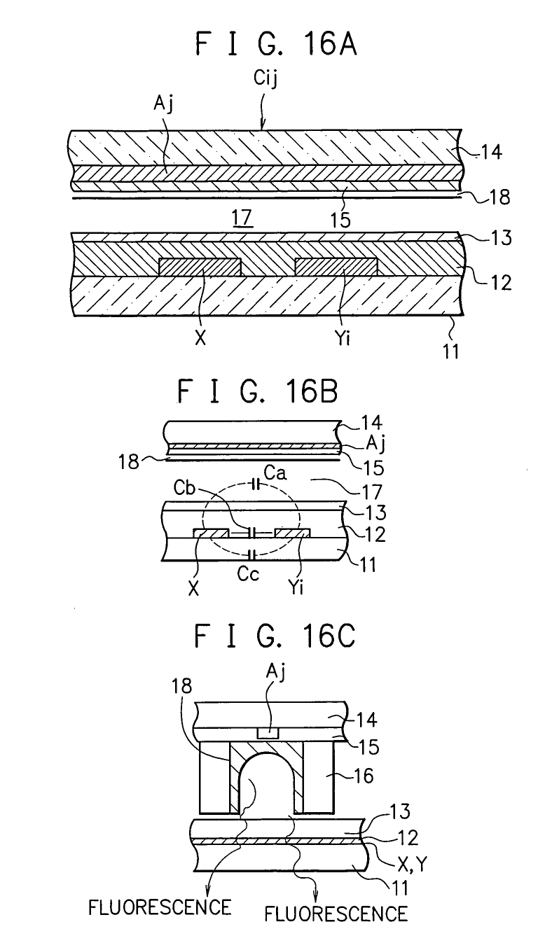

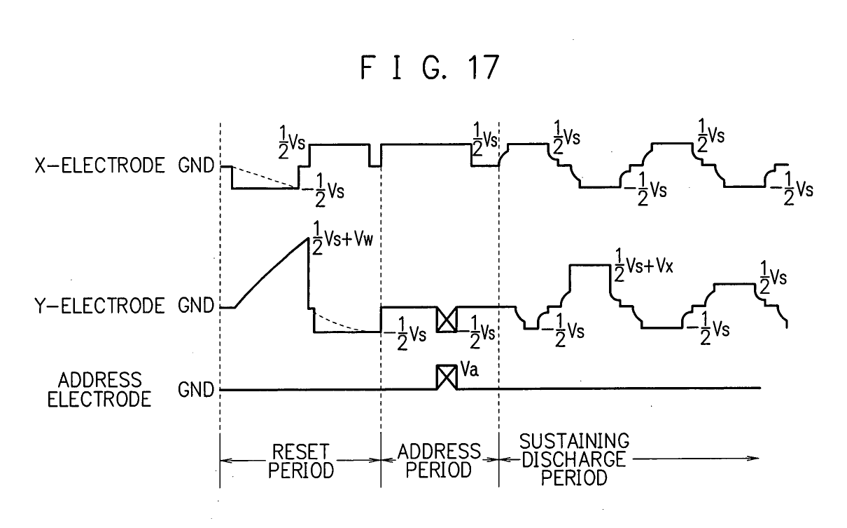

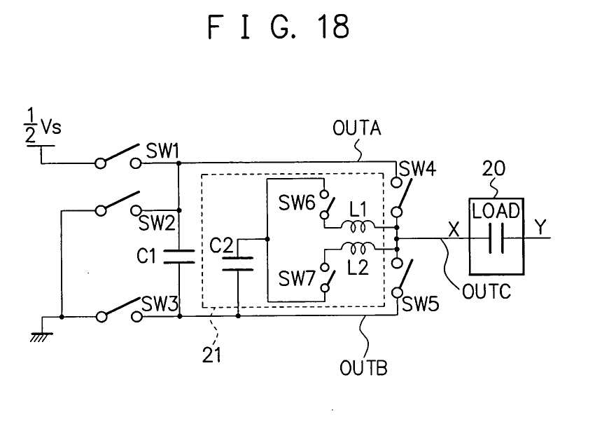

FIG. 1 is a diagram showing an example of a schematic configuration of a drive circuit of an AC-PDP (Plasma Display Panel) device based on a first embodiment. Further, the drive circuit of this embodiment shown in FIG. 1 can be applied to, for example, the AC-PDP device (a display device) 1 with the overall configuration shown in FIG. 15, and with the configuration of the cell shown in FIGS. 16A to 16C. The drive circuit of this embodiment is adaptable to the operations during the reset period or the address period shown in FIG. 17. Still more, the drive circuit is also adaptable to the additional operation of the voltage Vx for a first time to the scan electrode Y during the sustaining discharge period shown in FIG. 17. Additionally, in this FIG. 1, components to which the same reference numerals are designated as those in FIG. 18 exhibit the same functions. In FIG. 1, as in FIG. 18, only a schematic configuration of an X-side circuit is explained. A Y-side circuit has the same structure and operation as the X-side circuit and therefore, an explanation is omitted. Note that detailed circuit examples of both the X-side circuit and the Y-side circuit are explained later.

In FIG. 1, a capacitive load 20 (hereinafter, referred to as a “load 20”) is a sum of capacitance of a cell being formed between one common electrode X and one scan electrode Y. The common electrode X and the scan electrode Y are formed on the load 20. Here, the scan electrode Y is any scan electrode among the plural scan electrodes Y1 to Yn.

Switches SW1 and SW2 are connected serially between a power supply line (a first power line) of voltage (Vs/2) supplied from a power supply and a ground. A node between the aforementioned two switches SW1 and SW2 is connected to one terminal of a capacitor C1, and a switch SW3 is connected between the other terminal of the capacitor C1 and the ground. Note that a signal line connected to one terminal of the capacitor C1 is a first signal line OUTA, and that a signal line connected to the other terminal thereof is a second signal line OUTB.

Furthermore, a coil circuit A is connected between the node between the two switches. SW1 and SW2, and the ground. Additionally, both terminals of a coil circuit B are connected in parallel to both terminals of the switch SW3. In another expression, the coil circuit A is connected between the first signal line OUTA and the ground, and the coil circuit B is connected between the second signal line OUTB and the ground. Incidentally, the coil circuits A and B are circuits which include at least coils respectively, and the coils are configured so as to carry out L-C resonance with the load 20 through switches SW4 and SW5. In other words, a power recovery circuit is configured with the coil circuits A and B, and the load 20.

Moreover, the serially connected switches SW4 and SW5 are connected to the both terminals of the aforementioned capacitor C1. A node between these two switches SW4 and SW5 is connected to the common electrode X of the load 20 through an output line OUTC. Although not shown, a same circuit is connected to a side of the scan electrode Y of the load 20.

The aforementioned switches SW1 to SW5 are controlled by control signals respectively supplied from, for example, the drive control circuit 5 shown in FIG. 15. As described above, the drive control circuit 5 is configured using a logic circuit or the like, and it generates the control signals based on the display data D, the clock CLK, the horizontal synchronization signal HS, and the vertical synchronization signal VS, all being supplied externally. Then, these control signals are supplied to the switches SW1 to SW5. By this configuration, the drive circuit shown in FIG. 1 conducts sustaining discharge during the sustaining discharge period which is a period when the common electrode X and the scan electrode Y in a cell discharge.

Here, an operation of the aforementioned drive circuit is explained by illustrating a specific configuration of the coil circuits A and B.

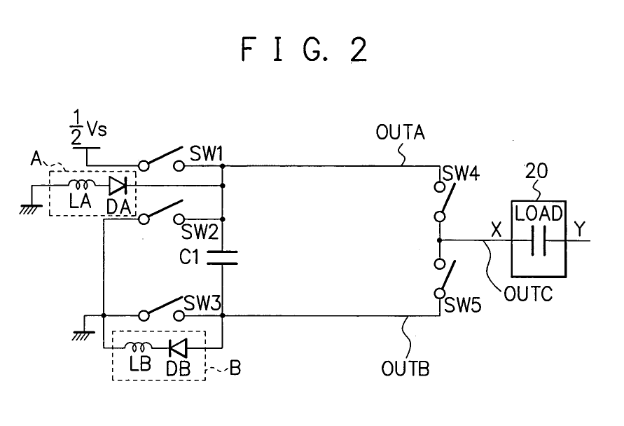

FIG. 2 is a schematic configuration of the drive circuit, showing a specific configuration of the coil circuits A and B shown in FIG. 1. As shown in FIG. 2, the coil circuit A includes a diode DA and a coil LA, and the coil circuit B includes a diode DB and a coil LB. A cathode terminal of the diode DA is connected to a node between the switches SW1 and SW2. In another expression, the cathode terminal of the diode DA is connected to the first signal line OUTA. Furthermore, an anode terminal of the diode DA is connected to a ground through the coil LA. A cathode terminal of the diode DB is connected to the ground through the coil LB. Still more, an anode terminal of the diode DB is connected to a node between the capacitor C1 and the switch SW3. In another expression, the anode terminal of the diode DB is connected to the second signal line OUTB.

As a forward direction of the aforementioned diode DA shows, the coil circuit A is a charge circuit for supplying an electric charge to the load 20 through the switch SW4. Furthermore, as a forward direction of the aforementioned diode DB shows, the coil circuit B is a discharge circuit for emitting the electric charge to the load 20 through the switch SW5. By controlling timing of charge processing of the charge circuit configured with the coil circuit A, the switch SW4, and the load 20, and discharge processing of the discharge circuit configured with the coil circuit B, the switch SW5, and the load 20, power recovery processing to the load 20 is realized. Note that in FIG. 2, the configuration of the other part of the coil circuits A and B is identical to that shown in FIG. 1 and therefore, an explanation is omitted.

Next, an operation of the drive circuit shown in FIG. 2 is explained.

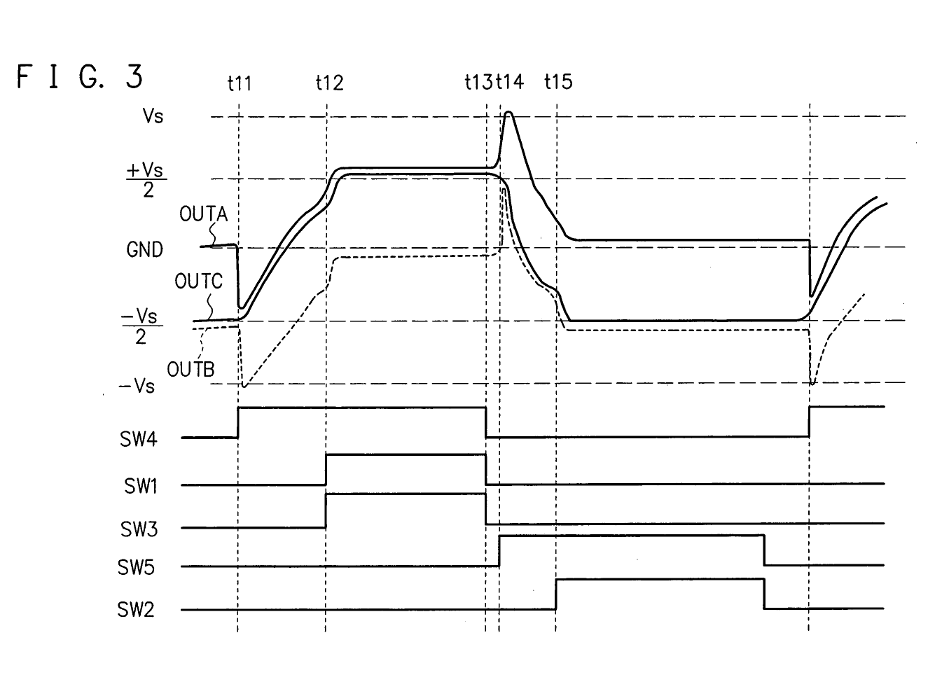

FIG. 3 is a waveform chart showing the operation of the drive circuit described in FIG. 2. In FIG. 3, voltage waveforms of the first signal line OUTA, the second signal line OUTB, and the output line OUTC are displayed together. Here, these voltage waveforms are aligned with the vertical axis of the waveform of the output line OUTC as a reference. The voltage waveform of the first signal line OUTA is slightly lifted up, and that of the second signal line OUTB is slightly lowered for eye-friendliness so that they do not wrap over the voltage waveform of the output line OUTC.

First, the switch SW4 is turned on in a state that the first signal line OUTA is on the ground level, that the second signal line OUTB and the output line OUTC are at −Vs/2, and that the switches SW1 to SW5 are turned off. Then the voltage −Vs/2 stored in the load 20 is transmitted to the first signal line OUTA through the switch SW4, and the voltage of the first signal line OUTA is turned to −Vs/2. Then, the voltage is applied to one terminal of the capacitor C1. This changes an electric potential of the other terminal of the capacitor C1 to −Vs and the voltage of the second signal line OUTB to −Vs as well (t11).

L-C resonance is carried out between the coil LA and the capacitance of the load 20 through the switch SW4 right after the time till, and an electric charge is supplied from the ground to the load 20 through the coil LA and the switch SW4. Accordingly, electric potentials of the first signal line OUTA and the output line OUTC increase from −Vs/2 toward +Vs/2 via the ground level. By this electric current flow, the voltage of the output line OUTC applied to the common electrode X gradually increases as shown in time between t11 and t12 in FIG. 3.

Next, by turning on the switches SW1 and SW3 before reaching a peak voltage appearing in this resonance, the voltage of the output line OUTC applied to the common electrode X is clamped to Vs/2 (t12). Then, the switches SW1, SW3 and SW4 are turned off (t13). The switch SW5 is turned on (t14). This applies the voltage Vs/2 stored in the load 20 to the second signal line OUTB through the switch SW5, and the voltage of the second signal line is turned to Vs/2. This increases the voltage of the first signal line OUTA to Vs.

L-C resonance is carried out between the coil LB and the capacitance of the load 20 through the switch SW5 right after the time t14. The electric charge is discharged from the load 20 to the ground through the coil LB and the switch SW5. Accordingly, the electric potentials of the second signal line OUTB and the output line OUTC decrease from +Vs/2 toward −Vs/2 via the ground level. By this electric current flow, the voltage of the output line OUTC applied to the common electrode X gradually decreases as shown in time between t14 and t15 in FIG. 3.

Next, by turning on the switch SW2 before reaching a peak voltage appearing in this resonance, the voltage of the output line OUTC applied to the common electrode X is clamped to −Vs/2 (t15). By the operation described above, the drive circuit shown in FIG. 2 applies the voltage changing from −Vs/2 to Vs/2 to the common electrode X during the sustaining discharge period. The voltages (+Vs/2, −Vs/2) having different polarities from the voltage applied to the common electrodes X are alternately applied to the scan electrodes Y of the respective display lines. The AC-PDP device conducts sustaining discharge by the above-mentioned method.

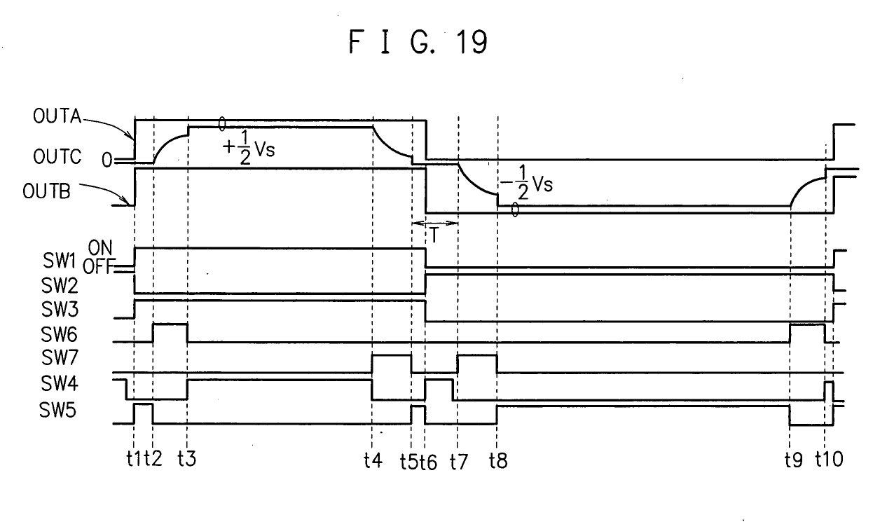

As shown in FIG. 3, when compared with FIG. 19 showing the conventional waveform chart, the period T of the ground level which exists in FIG. 19 does not exist in the voltage waveform of the output line OUTC in FIG. 3. In other words, when a sustain operation is carried out under a same period, the drive circuit of this embodiment can lengthen time for sustaining the voltage Vs/2 or the voltage −Vs/2 which are a top width and a bottom width of sustain discharge pulses when compared with related arts. Accordingly, as described above, time for wall charges to move is required during the sustaining discharge period, and the time therefor can be more absolutely secured. Furthermore, the drive circuit of this embodiment carries out sustaining discharge more stably while securing the same sustain time as the related arts, thereby an enlargement of an operation margin, an improvement of luminance of the panel P, and the like can be expected.

When the circuitry of the drive circuit of this embodiment shown in FIG. 2 is compared with the circuitry of the conventional drive circuit shown in FIG. 18, the number of switches is smaller by the number corresponding to the switches SW6 and SW7 in FIG. 18. This lowers complexity of controlling switches. Furthermore, there is no need for inserting a circuit of level-shifting a control signal which controls the switches SW6 and SW7 shown in FIG. 18, and for electrically separating a control signal circuit from a transmission channel of the control signal between the switches SW6 and SW7 by using a photocoupler or the like and therefore, the number of parts can be decreased. Still more, the capacitor C2 equipped in the drive circuit shown in FIG. 18 is eliminated in the drive circuit shown in FIG. 2. Accordingly, a circuit for supervising a voltage required for the capacitor C2 not shown in FIG. 18 is not required because the capacitor C2 is not included. This allows further decrease in the number of parts.

Next, a specific example of a circuit (including the side of the scan electrode Y) of the drive circuit shown in FIG. 2 is explained with reference to the drawing.

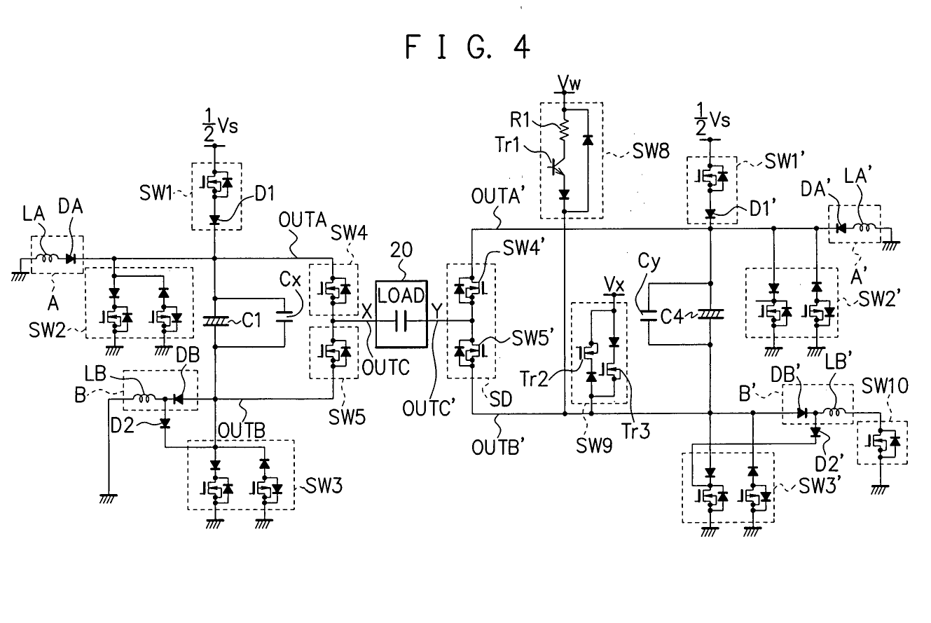

FIG. 4 is a diagram showing a specific circuit example of the drive circuit described in FIG. 2. In FIG. 4, the load 20 is a sum of capacitance of a cell being formed between one common electrode X and one scan electrode Y. The common electrode X and the scan electrode Y are formed on the load 20. Here, the scan electrode Y is any scan electrode among the plural scan electrodes Y1 to Yn shown in FIG. 15.

First, on the common electrode X side, switches SW1 and SW2 are connected serially between a power supply line of voltage (Vs/2) supplied from a power supply not shown in the diagram and a ground. A node between the two switches SW1 and SW2 is connected to one terminal of a capacitor C1, and a switch SW3 is connected between the other terminal of the capacitor C1 and the ground. Note that a capacitor Cx is connected in parallel to the capacitor C1.

Serially connected switches SW4 and SW5 are connected to the both terminals of the capacitor C1. A node between these two switches SW4 and SW5 is connected to the common electrode X of the load 20 through the output line OUTC.

As in FIG. 2, a coil circuit A includes a diode DA and a coil LA, and a coil circuit B includes a diode DB and a coil LB. A cathode terminal of the diode DA is connected to the node between the switches SW1 and SW2. An anode terminal of the diode DA is connected to the ground through the coil LA. A cathode terminal of the diode DB is connected to the ground through the coil LB and a switch SW3.

This switch SW3 is a switch for preventing the a voltage (Vs/2+Vw) or (Vs/2+Vx) applied to the second signal line OUTB from flowing straight to the ground during the aforementioned reset period, address period, and the like. An anode terminal of the diode DB is connected to a node between the capacitor C1 and the switch SW3. An anode terminal of a diode D2 is connected to the cathode terminal of the diode DB. A cathode terminal of the diode D2 is connected to the anode terminal of the diode DB. The cathode terminal of the diode DB is connected to the ground through the coil LB.

On the other hand, on the scan electrode Y side, switches SW1′ and SW2′ are connected serially between a power supply line of voltage (Vs/2) supplied from a power supply not shown in the drawing and the ground. A node between these two switches SW1′ and SW2′ is connected to one terminal of a capacitor C4, and a switch SW3′ is connected between the other terminal of this capacitor C4 and the ground. Note that a capacitor Cy is connected in parallel to the capacitor C4.

Moreover, serially connected switches SW4′ and SW5′ are connected to the both terminals of the capacitor C4. A node between these two switches SW4′ and SW5′ is connected to the scan electrode Y of the load 20 through an output line OUTC′. Note that a scan driver SD is configured with the switches SW4′ and SW5′. The scan driver SD outputs a scan pulse during scanning in the address period (refer to FIG. 17), and conducts a selection operation of the scan electrodes Y of each line. Note that a connecting line which connects the switch SW4′ to one terminal of the capacitor C4 is a third signal line OUTA′, and a connecting line which connects the switch SW5′ to the other terminal of the capacitor C4 is a fourth signal line OUTB′.

Furthermore, between the fourth signal line OUTB′ and the power supply line for generating the write voltage Vw (refer to FIG. 17), a switch SW8 including a resistor R1 and an npn transistor Tr1 is connected. Still more, between the fourth signal line OUTB′ and the power supply line for generating the voltage Vx (refer to FIG. 17), a switch SW9 including n-channel MOS transistors Tr2 and Tr3 is connected.

The third signal line OUTA′ is connected to the ground through a coil circuit A′. The fourth signal line OUTB′ is connected to the ground through a coil circuit B′. The coil circuit A′ includes a diode DA′ and a coil LA′ and the coil circuit B′ includes a diode DB′ and a coil LB′. A cathode terminal of the diode DA′ is connected to a node between the switches SW1′ and SW2′. An anode terminal of the diode DA′ is connected to the ground through the coil LA′.

A cathode terminal of the diode DB′ is connected to the ground through the coil LB′ and a switch SW10. The switch SW10 is a switch for preventing the voltages (Vs/2+Vw) or (Vs/2+Vx) applied to the fourth signal line OUTB′ from flowing straight to the ground during the aforementioned reset period, address period, and the like. An anode terminal of the diode DB′ is connected to a node between the capacitor C4 and the switch SW3′. An anode terminal of a diode D2′ is connected to a cathode terminal of the diode DB′. A cathode terminal of the diode D2′ is connected to the anode terminal of the diode DB′.

Note that the aforementioned switches SW1 to SW5, SW8 to SW10, SW1′ to SW5′ and transistors Tr1 to Tr3 are respectively controlled by the control signals supplied from the drive control circuit 5 shown in FIG. 15. For example, by performing switch control in the Y-side circuit with timing of a fall in the output line OUTC in the X-side circuit from Vs/2 to the ground level or from the ground level to −Vs/2, a power recovery operation of recovering an electric charge to the capacitor C4 through the ground is performed.

By the abovementioned configuration, the voltage changing from −Vs/2 to Vs/2 is applied to the common electrode X during the sustaining discharge period. The voltages (+Vs/2, −Vs/2) having different polarities from the voltage supplied to the common electrodes X are alternately applied to the scan electrodes Y of the respective display lines.

An example 2 which has a differently configured circuit from the one described in FIG. 2 as specific circuits of the aforementioned coil circuits A and B is explained.

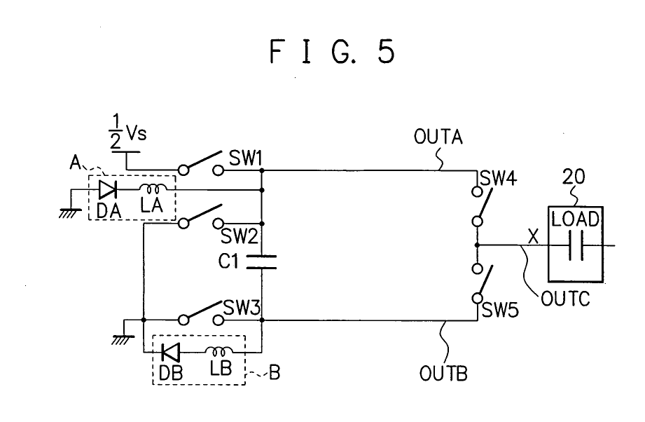

FIG. 5 is a diagram showing a schematic configuration of the drive circuit, showing a specific configuration of the coil circuits A and B shown in FIG. 1). The configuration in FIG. 5 differs from that in FIG. 2 in that a positional relationship shown in FIG. 2 between the diode DA and the coil LA relative to the ground is reversed in the coil circuit A, and that a positional relationship shown in FIG. 2 between the diode DB and the coil LB relative to the ground is reversed in the coil circuit B.

A cathode terminal of the diode DA is connected to a node between the switches SW1 and SW2 through the coil LA. In another expression, the cathode terminal of the diode DA is connected to the first signal line OUTA through the coil LA. Furthermore, an anode terminal of the diode DA is connected to a ground. A cathode terminal of the diode DB is connected to the ground. Still more, an anode terminal of the diode DB is connected to a node between the capacitor C1 and the switch SW3 through the coil LB. In another expression, the anode terminal of the diode DB is connected to the second signal line OUTB through the coil LB. Note that the configuration of the other part of the coil circuits A and B shown in FIG. 5 is the same as the one shown in FIG. 2 and therefore, an explanation thereof is omitted. Also the drive circuit shown in FIG. 5 obviously conducts the same operation as the one described in FIG. 2 and therefore, an explanation thereof is omitted.

An example 3 which has a differently configured circuit from the one described in FIG. 2 as specific circuits of the aforementioned coil circuits A and B, and an operation thereof are explained.

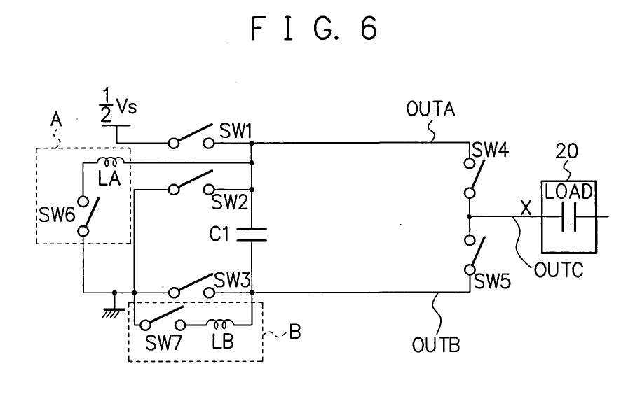

FIG. 6 is a schematic configuration of the drive circuit, showing a specific configuration of the coil circuits A and B shown in FIG. 1. The configuration in FIG. 6 differs from that in FIG. 2 in that the diode DA shown in FIG. 2 is replaced with a switch SW6 in the coil circuit A, and that the diode DB shown in FIG. 2 is replaced with a switch SW7 in the coil circuit B.

One terminal of the switch SW6 is connected to a node between the switches SW1 and SW2 through the coil LA. In another expression, one terminal of the switch SW6 is connected to the first signal line OUTA through the coil LA. Furthermore, the other terminal of the switch SW6 is connected to the ground. One terminal of the switch SW7 is connected to the ground. Still more, the other terminal of the switch SW7 is connected to a node between the capacitor C1 and the switch SW3 through the coil LB. In another expression, the other terminal of the switch SW7 is connected to the second signal line OUTB through the coil LB.

Next, an operation of the drive circuit shown in FIG. 6 is explained.

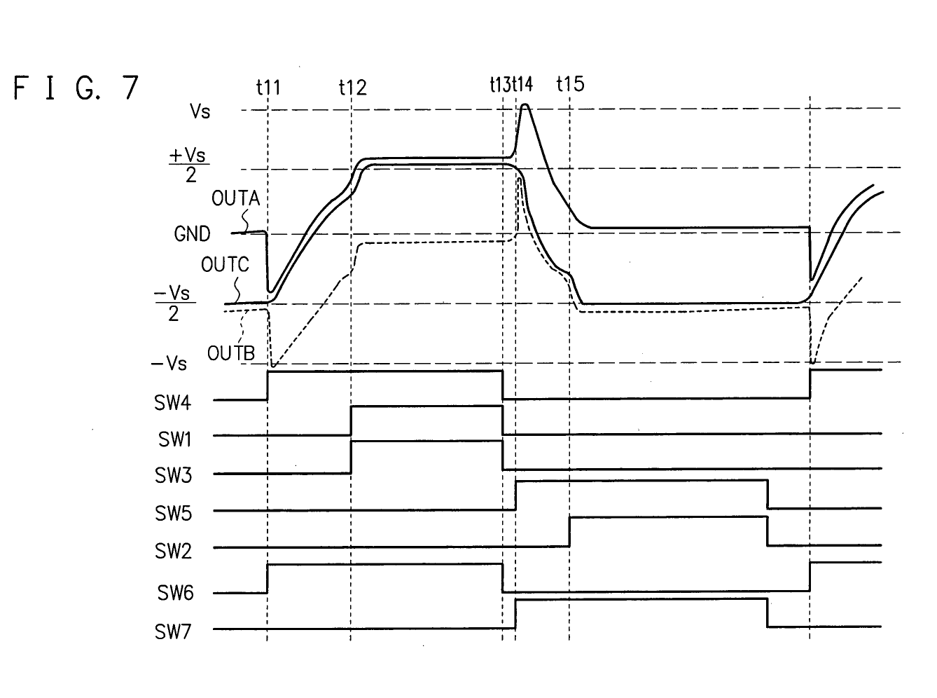

FIG. 7 is a waveform chart showing the operation of the drive circuit described in FIG. 6. In FIG. 7, voltage waveforms of the first signal line OUTA, the second signal line OUTB, and the output line OUTC are displayed together. Here, these voltage waveforms are aligned with the vertical axis of the waveform of the output line OUTC as a reference. The voltage waveform of the first signal line OUTA is slightly lifted up, and that of the second signal line OUTB is slightly lowered for eye-friendliness so that they do not wrap over the voltage waveform of the output line OUTC.

First, the switch SW4 and the switch SW6 are turned on in a state that the first signal line OUTA is on the ground level, that the second signal line OUTB and the output line OUTC are at −Vs/2, and that the switches SW1 to SW7 are turned off. Then the voltage −Vs/2 stored in the load 20 is transmitted to the first signal line OUTA through the switch SW4, and the voltage of the first signal line OUTA is turned to −Vs/2. Then, the voltage is supplied to one terminal of the capacitor C1. This changes the electric potential of the other terminal of the capacitor C1 to −Vs and the voltage of the second signal line OUTB to −Vs as well (t11).

L-C resonance is carried out between the coil LA and the capacitance of the load 20 through the switches SW4 and SW6 right after the time t11, and an electric charge is supplied from the ground to the load 20 through the coil LA and the switches SW4 and SW6. Accordingly, electric potentials of the first signal line OUTA and the output line OUTC increase from −Vs/2 toward +Vs/2 via the ground level. By this electric current flow, the voltage of the output line OUTC applied to the common electrode X gradually increases as shown in time between t11 and t12 in FIG. 7.

Next, by turning on the switches SW1 and SW3 before reaching a peak voltage appearing in this resonance, the voltage of the output line OUTC applied to the common electrode X is clamped to Vs/2 (t12). Then, the switches SW1, SW3, SW4 and SW6 are turned off (t13), and the switches SW5 and SW7 are turned on (t14). This applies the voltage Vs/2 stored in the load 20 to the second signal line OUTB through the switch SW5, and the voltage of the second signal line OUTB is turned to Vs/2. This increases the voltage of the first signal line OUTA to Vs.

L-C resonance is carried out between the coil LB and the capacitance of the load 20 through the switches SW5 and SW7 right after the time t14. The electric charge is discharged from the load 20 to the ground through the coil LB and the switches SW5 and SW7. Accordingly, the electric potentials of the second signal line OUTB and the output line OUTC decrease from +Vs/2 toward −Vs/2 via the ground level. By this electric current flow, the voltage of the output line OUTC applied to the common electrode X gradually decreases as shown in time between t14 and t15 in FIG. 7.

Next, by turning on the switch SW2 before reaching a peak voltage appearing in this resonance, the voltage of the output line OUTC applied to the common electrode X is clamped to −Vs/2 (t15). By the operation described above, the drive circuit shown in FIG. 6 applies the voltage changing from −Vs/2 to Vs/2 to the common electrode X during the sustaining discharge period. The voltages (+Vs/2, −Vs/2) having different polarities from the voltage supplied to the common electrodes X are alternately applied to the scan electrodes Y of the respective display lines. The AC-PDP device conducts sustaining discharge by the above-mentioned method.

As shown in FIG. 7, when compared with FIG. 19 of the conventional waveform chart, the period T of the ground level which exists in FIG. 19 does not exist in the voltage waveform of the output line OUTC in FIG. 7. In other words, when a sustain operation is carried out under a same period, the drive circuit of this embodiment can lengthen time for sustaining the voltage Vs/2 or the voltage −Vs/2 when compared with related arts. Accordingly, as described above, time for wall charges to move is required during the sustaining discharge period, and the time therefor can be more absolutely secured. Furthermore, the drive circuit of this embodiment carries out the sustain operation in a shorter period while securing the same sustain time as the related arts, thereby luminance of the panel P can be improved.

When the circuitry of the drive circuit of this embodiment shown in FIG. 6 is compared with the circuitry of the conventional drive circuit shown in FIG. 18, the drive circuit shown in FIG. 6 does not include the capacitor C2 that the drive circuit in FIG. 18 includes. Accordingly, a circuit for supervising a voltage required for the capacitor C2 not shown in FIG. 18 is not required. This decreases the number of parts of the drive circuit.

An example 4 which has a differently configured circuit from the one described in FIG. 2 as specific circuits of the aforementioned coil circuits A and B, and an operation thereof are explained.

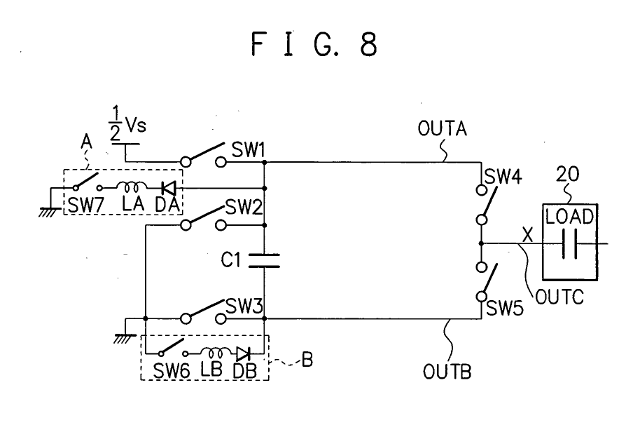

FIG. 8 is a schematic configuration of the drive circuit, showing a specific configuration of the coil circuits A and B shown in FIG. 1. The configuration in FIG. 8 differs from that in FIG. 2, in the coil circuit A, in that a forward direction of the diode DA shown in FIG. 8 is opposite to the direction thereof shown in FIG. 2, and that a switch SW7 is added. The configuration in FIG. 8 differs from that in FIG. 2, in the coil circuit B, in that a forward direction of the diode DB shown in FIG. 8 is opposite to the direction thereof shown in FIG. 2, and that a switch SW6 is added. In FIG. 8, the switch SW6 is a switch for specifying timing to supply an electric charge to the load 20. Additionally, the switch SW7 is a switch for specifying timing to discharge the electric charge to the load 20.

As shown in FIG. 8, the coil circuit A includes the diode DA, the coil LA, and the switch SW7. The coil circuit B includes the diode DB, the coil LB, and the switch SW6. An anode terminal of the diode DA is connected to a node between the switches SW1 and SW2. In another expression, the anode terminal of the diode DA is connected to the first signal line OUTA. A cathode terminal of the diode DA is connected to a ground through the coil LA and the switch SW7. An anode terminal of the diode DB is connected to the ground through the coil LB and the switch SW6. A cathode terminal of the diode DB is connected to a node between the capacitor C1 and the switch SW3. In another expression, the cathode terminal of the diode DB is connected to the second signal line OUTB.

As a forward direction of the aforementioned diode DA shows, the coil circuit A is a discharge circuit for emitting an electric charge to the load 20 through the switch SW4. Furthermore, as a forward direction of the aforementioned diode DB shows, the coil circuit B is a charge circuit for supplying the electric charge to the load 20 through the switch SW5. By controlling timing of discharge processing of the discharge circuit configured with the coil circuit A, the switch SW4, and the load 20, and charge processing of the charge circuit configured with the coil circuit B, the switch SW5, and the load 20, power recovery processing to the load 20 is realized. Note that, in FIG. 8, the configuration of the other part of the coil circuits A and B includes the same configuration as the one shown in FIG. 2 and therefore, an explanation thereof is omitted.

Next, an operation of the drive circuit shown in FIG. 8 is explained.

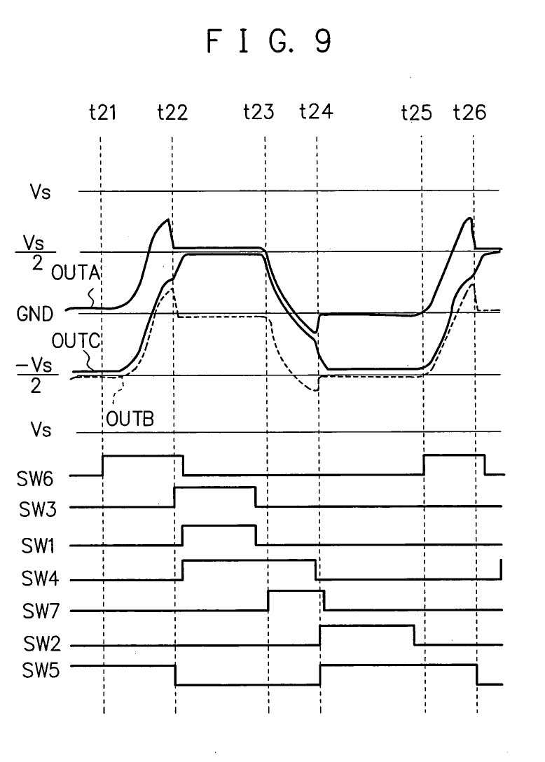

FIG. 9 is a waveform chart showing the operation of the drive circuit described in FIG. 8. In FIG. 9, voltage waveforms of the first signal line OUTA, the second signal line OUTB, and the output line OUTC are displayed together. Here, these voltage waveforms are aligned with the vertical axis of the waveform of the output line OUTC as a reference. The voltage waveform of the first signal line OUTA is slightly lifted up, and that of the second signal line OUTB is slightly lowered for eye-friendliness so that they do not wrap over the voltage waveform of the output line OUTC.

First, the switch SW6 is turned on in a state that the first signal line OUTA is on the ground level, that the second signal line OUTB and the output line OUTC are at −Vs/2, that the switches SW1 to SW4, SW6, and SW7 are turned off, and that the switch SW5 is turned on. Then the voltage −Vs/2 stored in the load 20 is transmitted to the second signal line OUTB through the switch SW5 (t21).

L-C resonance is carried out between the coil LB and the capacitance of the load 20 through the switches SW5 and SW6 right after the time t21, and an electric charge is supplied from the ground to the load 20 through the coil LB and the switches SW5 and SW6. Accordingly, electric potentials of the second signal line OUTB and the output line OUTC increase from −Vs/2 toward +Vs/2 via the ground level. By this electric current flow, the voltage of the output line OUTC applied to the common electrode X gradually increases as shown in time between t21 and t22 in FIG. 9.

Next, by turning on the switches SW1, SW3, and SW4 and turning off the switches SW5 and SW6 before reaching a peak voltage appearing in this resonance, the voltage of the output line OUTC applied to the common electrode X is clamped to Vs/2 (t22). Then, the switches SW1 and SW3 are turned off, and the switch SW7 is turned on (t23). This supplies the voltage Vs/2 stored in the load 20 to the first signal line OUTA through the switch SW4.

L-C resonance is carried out between the coil LA and the capacitance of the load 20 through the switches SW4 and SW7 right after the time t23. The electric charge is discharged from the load 20 to the ground through the coil LA and the switches SW4 and SW7. Accordingly, the electric potentials of the first signal line OUTA and the output line OUTC decrease from +Vs/2 toward −Vs/2 via the ground level. By this electric current flow, the voltage of the output line OUTC applied to the common electrode X gradually decreases as shown in time between t23 and t24 in FIG. 9.

Next, by turning off the switches SW4 and SW7 and turning on the switches SW2 and SW5 before reaching a peak voltage appearing in this resonance, the voltage of the output line OUTC applied to the common electrode X is clamped to −Vs/2 (t24). Furthermore, the switch SW2 is turned off right before turning on the switch SW6 at a time t25. By the operation described above, the drive circuit shown in FIG. 8 applies the voltage changing from −Vs/2 to Vs/2 to the common electrode X during the sustaining discharge period. The voltages (+Vs/2, −Vs/2) having different polarities from the voltage supplied to the common electrodes X are alternately applied to the scan electrodes Y of the respective display lines. The AC-PDP device conducts sustaining discharge by the above-mentioned method.

As shown in FIG. 9, when compared with FIG. 19 of the conventional waveform chart, the period T of the ground level which exists in FIG. 19 does not exist in the voltage waveform of the output line OUTC in FIG. 9. In other words, when a sustain operation is carried out under a same period, the drive circuit of this embodiment can lengthen time for sustaining the voltage Vs/2 or the voltage −Vs/2 which are a top width and a bottom width of sustain discharge pulses when compared with related arts. Accordingly, as described above, time for wall charges to move is required during the sustaining discharge period, and the time therefor can be more absolutely secured. Furthermore, the drive circuit of this embodiment carries out sustaining discharge more stably while securing the same sustain time as the related arts, thereby an enlargement of an operation margin, an improvement of luminance of the panel P, and the like can be expected.

When the circuitry of the drive circuit of this embodiment shown in FIG. 8 is compared with the circuitry of the conventional drive circuit shown in FIG. 18, the drive circuit shown in FIG. 8 does not include the capacitor C2 that the drive circuit in FIG. 18 includes. Accordingly, a circuit for supervising a voltage required for the capacitor C2 not shown in FIG. 18 is not required. This decreases the number of parts of the drive circuit. Furthermore, regarding the voltage applied to the capacitor C1, the voltage supervisory circuit can be simplified or the voltage supervisory circuit is not required because controlling becomes easier due to less number of switches and because high-precision controlling to the ground level required for a conventional ground level period is not required.

### Second Embodiment

A schematic configuration of a drive circuit in a second embodiment having a different configuration from the drive circuit shown in FIG. 1 is explained with reference to the drawings.

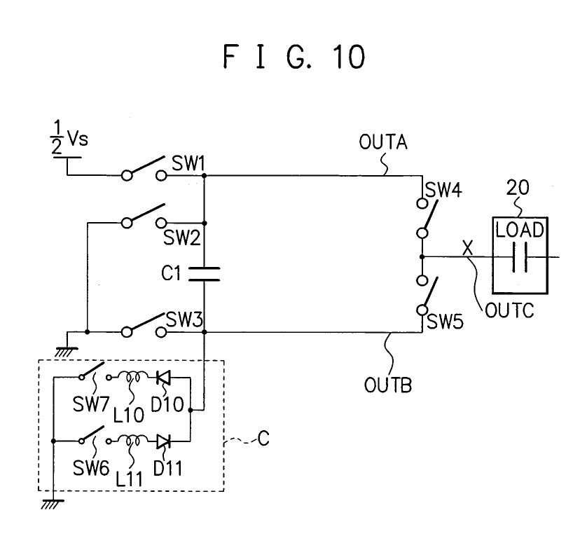

FIG. 10 is a diagram showing the schematic configuration of the drive circuit in the second embodiment having the different configuration from the drive circuit described in FIG. 1. Further, as in FIG. 1, the drive circuit of this embodiment shown in FIG. 10 can be applied to, for example, the AC-PDP device (a display device) 1 with the overall configuration shown in FIG. 15, and the configuration of the cell shown in FIGS. 16A to 16C. The drive circuit of this embodiment is adaptable to the operations during the reset period or the address period shown in FIG. 17. Additionally, in this FIG. 10, components to which the same reference numerals are designated as those in FIG. 1 exhibit the same functions and therefore an explanation is omitted. In FIG. 10, as in FIG. 1, only a schematic configuration of the X-side circuit is explained. The Y-side circuit has the same structure and operation as the X-side circuit and therefore, an explanation thereof is omitted.

In FIG. 10, a load 20 is a sum of capacitance of a cell being formed between one common electrode X and one scan electrode Y. Switches SW1 and SW2 are connected serially between a power supply line of voltage (Vs/2) supplied from a power supply and a ground. A node between the aforementioned two switches SW1 and SW2 is connected to one terminal of a capacitor C1, and a switch SW3 is connected between the other terminal of the capacitor C1 and the ground. Note that a signal line connected to one terminal of the capacitor C1 is a first signal line OUTA, and that a signal line connected to the other terminal thereof is a second signal line OUTB.

A node between the other terminal of the capacitor C1 and the switch SW3 is connected to one terminal of a coil circuit C. The other terminal of the coil circuit C is connected to the ground. In another expression, the coil circuit C is connected between the second signal line OUTB and the ground. The coil circuit C includes diodes D10, D11, coils L10, L11, and switches SW6, SW7.

A cathode terminal of the diode D10 is connected to the ground through the coil L10 and the switch SW7. An anode terminal of the diode D10 is connected to a node between the capacitor C1 and the switch SW3. An anode terminal of the diode D11 is connected to the ground through the coil L11 and the switch SW6. A cathode terminal of the diode D11 is connected to the node between the capacitor C1 and the switch SW3. In other words, the anode terminal of the diode D10 and the cathode terminal of the diode D11 are connected to the second signal line OUTB.

As a forward direction of the aforementioned diode D10 shows, the coil L10 includes a discharge function for emitting an electric charge to the load 20 through the switch SW5. Furthermore, as a forward direction of the diode D11 shows, the coil L11 includes a charge function for supplying the electric charge to the load 20 through the switch SW5. By controlling the discharge function configured with the coil L10, the switch SW5, and the load 20, and the charge function configured with the coil L11, the switch SW5, and the load 20, a power recovery function to the load 20 is realized. Note that the configuration of the coil circuit C is not limited to the above, but any circuit is acceptable as long as the circuit includes a coil and the coil is configured to carry out L-C resonance with the load 20.

Moreover, a switch SW4 and the switch SW5 which are serially connected are connected to the both terminals of the aforementioned capacitor C1. A node between these two switches SW4 and SW5 is connected to the common electrode X of the load 20 through an output line OUTC. Although not shown, a same circuit is connected to the side of the scan electrode Y of the load 20. Incidentally, the aforementioned switches SW1 to SW5 are controlled by control signals respectively supplied from, for example, the drive control circuit 5 shown in FIG. 15. By this configuration, the drive circuit conducts sustaining discharge during the sustaining discharge period which is a period when the common electrode X and the scan electrode Y in the cell discharge.

Next, an operation of the drive circuit shown in FIG. 10 is explained.

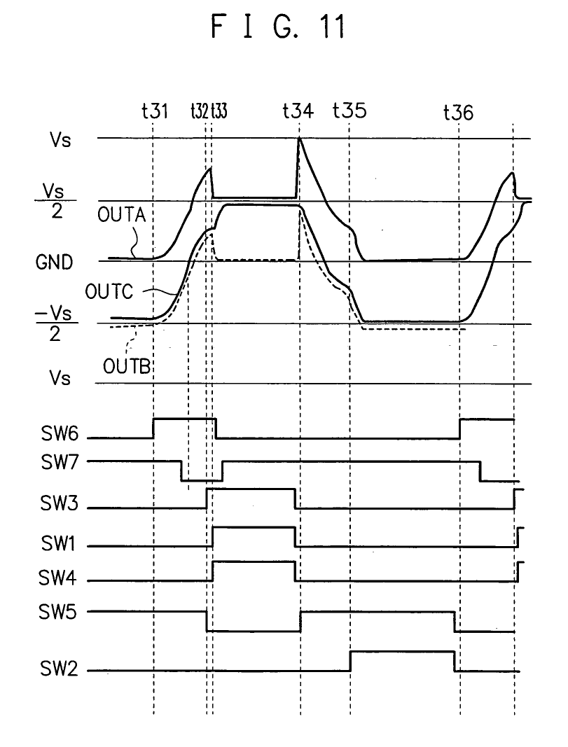

FIG. 11 is a waveform chart showing the operation of the drive circuit described in FIG. 10. In FIG. 11, voltage waveforms of the first signal line OUTA, the second signal line OUTB, and the output line OUTC are displayed together. Here, these voltage waveforms are aligned with the vertical axis of the waveform of the output line OUTC as a reference. The voltage waveform of the first signal line OUTA is slightly lifted up, and that of the second signal line OUTB is slightly lowered for eye-friendliness so that they do not wrap over the voltage waveform of the output line OUTC.

First, the switch SW6 is turned on in a state that the first signal line OUTA is on the ground level, that the second signal line OUTB and the output line OUTC are at −Vs/2, that the switches SW1 to SW4, and SW6 are turned off, and that the switches SW5 and SW7 are turned on (t31). L-C resonance is carried out between the coil L11 and the capacitance of the load 20 through the switches SW5 and SW6, and an electric charge is supplied from the ground to the load 20 through the coil L11, the diode D11, and the switches SW5 and SW6. Accordingly, electric potentials of the second signal line OUTB and the output line OUTC increase from −Vs/2 toward +Vs/2 via the ground level. By this electric current flow, the voltage of the output line OUTC applied to the common electrode X gradually increases as shown in time between t31 and t32 in FIG. 11. The switch SW7 is turned off before the electric potential of the second signal line OUTB exceeds the ground level during time between t31 and t32.

Next, by turning off the switch SW5 and turning on the switch SW3 before reaching a peak voltage appearing in this resonance, the voltage of the second signal line OUTB is changed to the ground level (t32). Additionally, the voltage of the first signal line OUTA is changed to Vs/2 according to the change of the second signal line OUTB. Then, the switches SW1, SW4, and SW7 are turned on, and the switch SW6 is turned off. This applies the voltage Vs/2 of the first signal line OUTA to the load 20 (t33). Accordingly, the voltage of the output line OUTC is clamped to Vs/2.

The switches SW1, SW3, and SW4 are turned off right before the time t34. Then, the switch SW5 is turned on at the time t34. This supplies the voltage Vs/2 stored in the load 20 to the second signal line OUTB through the switch SW5, so the voltage of the second signal line OUTB is turned to Vs/2. The voltage of the first signal line OUTA increases to Vs.

L-C resonance is carried out between the coil L10 and the capacitance of the load 20 through the switches SW5 and SW7 right after the time t34. The electric charge is discharged from the load 20 to the ground through the diode D10 and the coil L10 in the coil circuit C, and the switches SW5 and SW7. Accordingly, the electric potentials of the second signal line OUTB and the output line OUTC decrease from +Vs/2 toward −Vs/2 via the ground level. By this electric current flow, the voltage of the output line OUTC applied to the common electrode X gradually decreases as shown in time between t34 and t35 in FIG. 11.

Next, by turning on the switch SW2 before reaching a peak voltage appearing in this resonance, the voltage of the output line OUTC applied to the common electrode X is clamped to −Vs/2 (t35). By the operation described above, the drive circuit shown in FIG. 10 applies the voltage changing from −Vs/2 to Vs/2 to the common electrode X during the sustaining discharge period. The voltages (+Vs/2, −Vs/2) having different polarities from the voltage supplied to the common electrodes X are alternately applied to the scan electrodes Y of the respective display lines. The AC-PDP device conducts sustaining discharge by the above-mentioned method.

As shown in FIG. 11, when compared with FIG. 19 of the conventional waveform chart, the period T of the ground level which exists in FIG. 19 does not exist in the voltage waveform of the output line OUTC in FIG. 11. In other words, when a sustain operation is carried out under a same period, the drive circuit of this embodiment can lengthen time for sustaining the voltage Vs/2 or the voltage −Vs/2 which are a top width and a bottom width of sustain discharge pulses when compared with related arts. Accordingly, as described above, time for wall charges to move is required during the sustaining discharge period, and the time therefor can be more absolutely secured. Furthermore, the drive circuit of this embodiment carries out sustaining discharge more stably while securing the same sustain time as the related arts, thereby an enlargement of an operation margin and an improvement of luminance of the panel P can be expected.

When the circuitry of the drive circuit of this embodiment shown in FIG. 10 is compared with the circuitry of the conventional drive circuit shown in FIG. 18, the drive circuit shown in FIG. 10 does not include the capacitor C2 that the drive circuit in FIG. 18 includes. Accordingly, a circuit for supervising a voltage required for the capacitor C2 not shown in FIG. 18 is not required. This decreases the number of parts of the drive circuit.

### Third Embodiment

A schematic configuration of a drive circuit in a third embodiment having a different configuration from the drive circuit shown in FIG. 1 is explained with reference to the drawings.

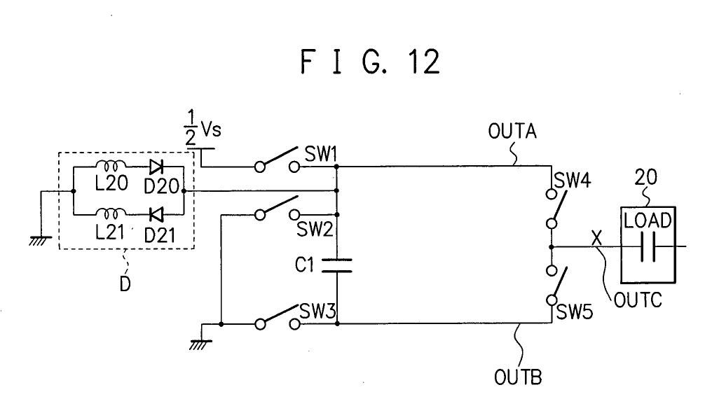

FIG. 12 is a diagram showing the schematic configuration of the drive circuit in the third embodiment having the different configuration from the drive circuit described in FIG. 1. Further, as in FIG. 1, the drive circuit of this embodiment shown in FIG. 12 can be applied to, for example, the AC-PDP device (a display device) 1 with the overall configuration shown in FIG. 15 and the configuration of the cell shown in FIGS. 16A to 16C. The drive circuit of this embodiment is adaptable to the operations during the reset period or the address period shown in FIG. 17. Additionally, in this FIG. 12, components to which the same reference numerals are designated as those in FIG. 1 exhibit the same functions and therefore an explanation thereof is omitted. In FIG. 12, as well as in FIG. 1, only a schematic configuration of the X-side circuit is explained. The Y-side circuit has the same structure and operation as the X-side circuit and therefore, an explanation is omitted.

In FIG. 12, a load 20 is a sum of capacitance of a cell being formed between one common electrode X and one scan electrode Y. Switches SW1 and SW2 are connected serially between a power supply line of voltage (Vs/2) supplied from a power supply and a ground. A node between the aforementioned two switches SW1 and SW2 is connected to one terminal of a capacitor C1, and a switch SW3 is connected between the other terminal of the capacitor C1 and the ground. Note that a signal line connected to one terminal of the capacitor C1 is a first signal line OUTA, and that a signal line connected to the other terminal thereof is a second signal line OUTB.

The node between the switches SW1 and SW2 is connected to one terminal of a coil circuit D. The other terminal of the coil circuit D is connected to the ground. In another expression, the coil circuit D is connected between the second signal line OUTB and the ground. The coil circuit D includes diodes D20, D21, and coils L20, L21.

An anode terminal of the diode D20 is connected to the ground through the coil L20. A cathode terminal of the diode D20 is connected to the node between the switches SW1 and SW2. Furthermore, a cathode terminal of the diode D21 is connected to the ground through the coil L21. An anode terminal of the diode D21 is connected to the node between the switches SW1 and SW2. In other words, the cathode terminal of the diode D20 and the anode terminal of the diode D21 are connected to the first signal line OUTA.

As a forward direction of the aforementioned diode D20 shows, the coil L20 has a charge function for supplying an electric charge to the load 20 through the switch SW4. Furthermore, as a forward direction of the diode D21 shows, the coil L21 has a discharge function for emitting the electric charge to the load 20 through the switch SW4. By controlling the charge function configured with the coil L20, the switch SW4, and the load 20, and the discharge function configured with the coil L21, the switch SW4, and the load 20, a power recovery function to the load 20 is realized. Note that the configuration of the coil circuit D is not limited to the above, but any circuit is acceptable as long as the circuit includes a coil and the coil is configured to carry out L-C resonance with the load 20 through the switch SW4.

Moreover, the serially connected switches SW4 and SW5 are connected to the both terminals of the aforementioned capacitor C1. A node between these two switches SW4 and SW5 is connected to the common electrode X of the load 20 through the output line OUTC. Although not shown, a same circuit is connected to the side of the scan electrode Y of the load 20. Incidentally, the aforementioned switches SW1 to SW5 are controlled by control signals respectively supplied from, for example, the drive control circuit 5 shown in FIG. 15. By this configuration, the drive circuit conducts sustaining discharge during the sustaining discharge period which is a period when the common electrode X and the scan electrode Y in the cell discharge.

Next, an operation of the drive circuit shown in FIG. 12 is explained.

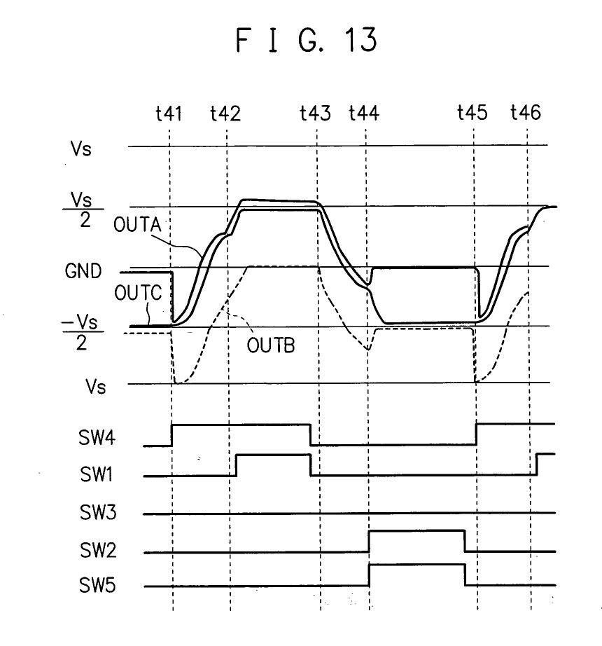

FIG. 13 is a waveform chart showing the operation of the drive circuit described in FIG. 12. In FIG. 13, voltage waveforms of the first signal line OUTA, the second signal line OUTB, and the output line OUTC are displayed together. Here, these voltage waveforms are aligned with the vertical axis of the waveform of the output line OUTC as a reference. The voltage waveform of the first signal line OUTA is slightly lifted up, and that of the second signal line OUTB is slightly lowered for eye-friendliness so that they do not wrap over the voltage waveform of the output line OUTC.

First, the switch SW4 is turned on in a state that the first signal line OUTA is on the ground level, that the second signal line OUTB and the output line OUTC are at −Vs/2, and that the switches SW1 to SW5 are turned off (t41). Accordingly, the voltage of the first signal line OUTA is rapidly changed to −Vs/2, and that of the second signal line OUTB is turned to −Vs. Right after the time t41, L-C resonance is carried out between the coil L20 and the capacitance of the load 20 through the switch SW4, and an electric charge is supplied from the ground to the load 20 through the coil L20 and the diode D20 in the coil circuit D, and the switch SW4. Accordingly, electric potentials of the first signal line OUTA and the output line OUTC increase from −Vs/2 toward +Vs/2 via the ground level. By this electric current flow, the voltage of the output line OUTC applied to the common electrode X gradually increases as shown in time between t41 and t42 in FIG. 13.

Next, by turning on the switch SW1 before reaching a peak voltage appearing in this resonance, the voltage of the first signal line OUTA is clamped to Vs/2 (t42). Accordingly, the voltage of the output line OUTC is clamped to Vs/2. Right before the time t43, the switch SW1 is turned off (t43). L-C resonance is carried out between the coil L21 and the capacitance of the load 20 through the switch SW4. The electric charge is discharged from the load 20 to the ground through the coil L21, the diode D21, and the switch SW4. Accordingly, the electric potentials of the first signal line OUTA and the output line OUTC decrease from +Vs/2 toward −Vs/2 via the ground level. By this electric current flow, the voltage of the output line OUTC applied to the common electrode X gradually decreases as shown in time between t43 and t44 in FIG. 13.

Next, by turning on the switch SW2 and the switch SW5 before reaching a peak voltage appearing in this resonance, the voltage of the output line OUTC applied to the common electrode X is clamped to −Vs/2 (t44). By the operation described above, the drive circuit shown in FIG. 12 applies the voltage changing from −Vs/2 to Vs/2 to the common electrode X during the sustaining discharge period. The voltages (+Vs/2, −Vs/2) having different polarities from the voltage applied to the common electrodes X are alternately applied to the scan electrodes Y of the respective display lines. The AC-PDP device conducts sustaining discharge by the above-mentioned method.

As shown in FIG. 13, when compared with FIG. 19 of the conventional waveform chart, the period T of the ground level which exists in FIG. 19 does not exist in the voltage waveform of the output line OUTC in FIG. 13. In other words, when a sustain operation is carried out under a same period, the drive circuit of this embodiment can lengthen time for sustaining the voltage Vs/2 or the voltage −Vs/2 which are a top width and a bottom width of sustain discharge pulses when compared with related arts. Accordingly, as described above, time for wall charges to move is required during the sustaining discharge period, and the time therefor can be more absolutely secured. Furthermore, the drive circuit of this embodiment carries out sustaining discharge more stably while securing the same sustain time as the related arts and thereby, an enlargement of an operation margin and an improvement of luminance of the panel P, and the like can be expected.

When the circuitry of the drive circuit of this embodiment shown in FIG. 12 is compared with the circuitry of the conventional drive circuit shown in FIG. 18, the number of switches is smaller by the number corresponding to the switches SW6 and SW7 in FIG. 18. This lowers complexity of controlling switches. Furthermore, there is no need for inserting a circuit of level shifting a control signal which controls the switches SW6 and SW7 shown in FIG. 18, and for electrically separating a control signal circuit from a transmission channel of the control signal between the switches SW6 and SW7 by using a photocoupler or the like and therefore, the number of parts can be decreased. Still more, the capacitor C2 equipped in the drive circuit shown in FIG. 18 is eliminated in the drive circuit shown in FIG. 12. Accordingly, a circuit for supervising a voltage required for the capacitor C2 not shown in FIG. 18 is not required. This can further decrease the number of parts.

### Fourth Embodiment

A schematic configuration of a drive circuit of a fourth embodiment having a partly different configuration from the drive circuit described in FIG. 1 is explained with reference to the drawings.

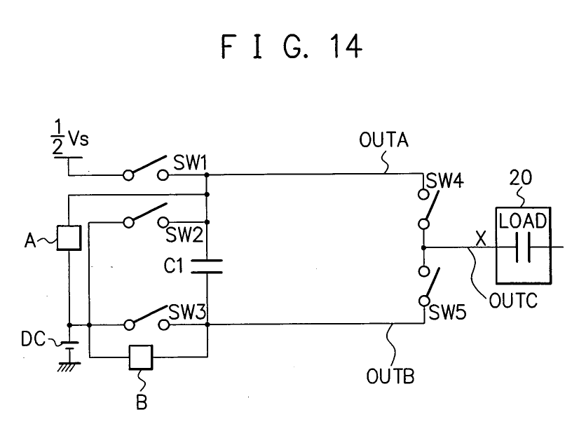

FIG. 14 is a diagram showing the schematic configuration example of the drive circuit in the fourth embodiment having the partly different configuration from the drive circuit shown in FIG. 1. The configuration in FIG. 14 differs from that in FIG. 2 in that a power supply circuit DC is inserted to a connecting line which connects a switch SW2 or a switch SW3 in FIG. 1 and a ground. The configuration of the other part is the same as the one shown in FIG. 1 and therefore, an explanation is omitted. In other words, the power line (a second power line) from the power supply circuit DC is connected to the switch SW2 and the switch SW3.

Here, the power supply circuit DC is a power supply circuit for outputting any constant voltage (a third electric potential) of ±Pv (V). This adjusts an electric potential of the first signal line (a first electric potential) OUTA and that of the second signal line (a second electric potential) OUTB. By the abovementioned configuration, for example, when the coil circuits A and B shown in FIG. 14 are configured as the ones shown in FIG. 2, the entire voltage waveform of the output line OUTC shown in FIG. 3 can be fluctuated according to an output voltage of the power supply circuit DC.

The explanations of the above mentioned embodiments are given regarding the case where the electrode X is a common electrode. The same effect can be obtained in cases when the electrode X is divided into some electrodes or when the electrode X is connected to plural circuits. Note that, in these cases, the aforementioned capacitive load is defined according to the number of divided units or the number of the plural circuits.

### Fifth Embodiment

Next, a schematic configuration of a drive circuit according to a fifth embodiment, which is a modification of the drive circuit according to the third embodiment shown in FIG. 12, is explained with reference to the drawings.

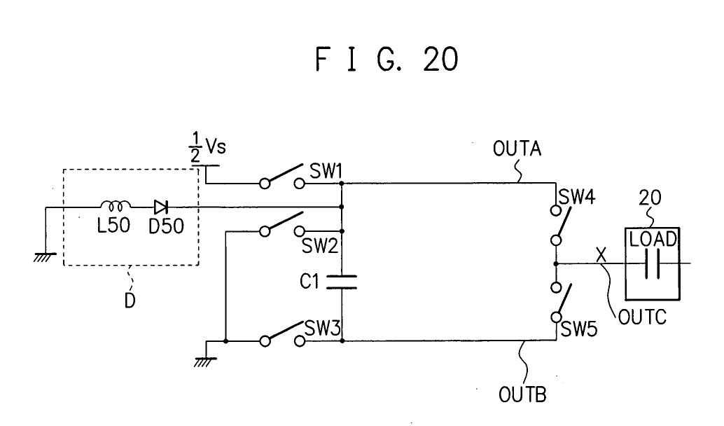

FIG. 20 shows the schematic configuration of the drive circuit according to the fifth embodiment, which is a modification of the drive circuit according to the third embodiment shown in FIG. 12. The drive circuit according to the fifth embodiment shown in FIG. 20 can be applied to, for example, the AC-PDP device (a display device) 1 with the overall configuration shown in FIG. 15 and the configuration of the cell shown in FIGS. 16A to 16C, as in FIG. 12. In FIG. 20, components denoted by the same reference numerals as those in FIG. 12 have the same functions, and therefore an explanation thereof is omitted. Also, in FIG. 20, as in FIG. 12, only a schematic configuration of the X-side circuit is explained. The Y-side circuit has the same structure and operation as the X-side circuit and therefore an explanation is omitted.

The drive circuit according to the fifth embodiment shown in FIG. 20 is different from the drive circuit according to the third embodiment shown in FIG. 12 in the internal configuration of the coil circuit D. Therefore, the configuration of the other part than the coil circuit D in the drive circuit shown in FIG. 20 is not explained.

As shown in FIG. 20, the coil circuit D includes a diode D50 and a coil C50. An anode terminal of the diode D50 is connected to a ground through the coil L50. A cathode terminal of the diode D50 is connected to a node between switches SW1 and SW2. That is, the cathode terminal of the diode D50 is connected to a first signal line OUTA.

As a forward direction of the diode D50 indicates, the coil L50 has a charge function of supplying an electric charge to a load 20 through a switch SW4. In other words, the coil L50, the switch SW4, and the load 20 realize a charge function using L-C resonance to the load 20. The configuration of the coil circuit D is not limited to the above-described configuration, but any circuit is acceptable as long as the circuit includes at least the coil 50 and the coil L50 is configured to carry out charge by using L-C resonance with the load 20 through the switch SW4.

Although not shown in the figure, a same circuit is connected to the side of the scan electrode Y of the load 20. The switches SW1 to SW5 shown in FIG. 20 are controlled by control signals supplied from the drive control circuit 5 shown in FIG. 15. With this configuration, the drive circuit of this embodiment performs sustaining discharge during the sustaining discharge period, when the common electrode X and the scan electrode Y in the cell discharge.

Next, an operation of the drive circuit shown in FIG. 20 is explained.

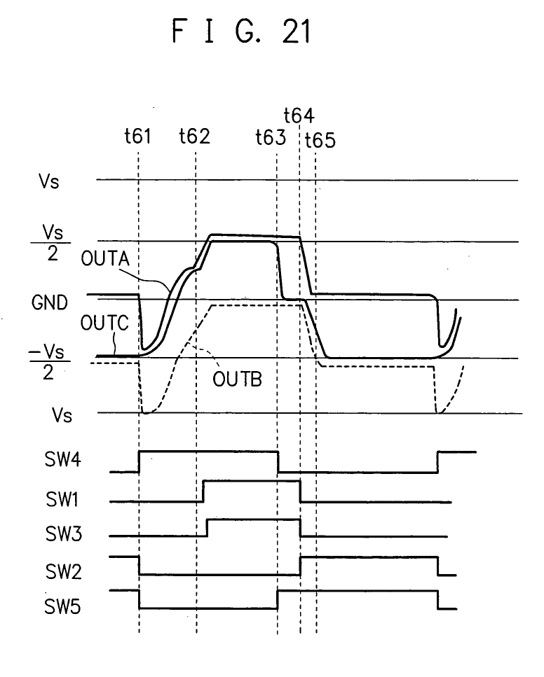

FIG. 21 is a waveform chart showing the operation of the drive circuit shown in FIG. 20. In FIG. 21, voltage waveforms of the first signal line OUTA, the second signal line OUTB, and the output line OUTC are displayed together. Here, these voltage waveforms are aligned with the vertical axis of the waveform of the output line OUTC as a reference. The voltage waveform of the first signal line OUTA is slightly lifted up, and that of the second signal line OUTB is slightly lowered for eye-friendliness so that they do not wrap over the voltage waveform of the output line OUTC.

First, the switch SW4 is turned on and the switches SW2 and SW5 are turned off in a state that the first signal line OUTA is on the ground level, that the second signal line OUTB and the output line OUTC are at −Vs/2, that the switches SW1, SW3, and SW4 are turned off, and that the switches SW2 and SW5 are turned on (t61). Accordingly, the voltage of the first signal line OUTA drops straight to −Vs/2, and that of the second signal line OUTB drops to −Vs. Right after the time t61, L-C resonance is carried out between the coil L50 and the capacitance of the load 20 through the switch SW4, so that an electric charge is supplied from the ground to the load 20 through the coil L50 and the diode D50 in the coil circuit D and the switch SW4. Accordingly, the electric potentials of the first signal line OUTA and the output line OUTC increase from −Vs/2 toward +Vs/2 via the potential of the ground level. By this electric current flow, the voltage of the output line OUTC applied to the common electrode X gradually increases as shown in time between t61 and t62 in FIG. 21.

Then, by turning on the switches SW1 and SW3 before reaching a peak voltage appearing in this resonance, the voltage of the first signal line OUTA is clamped to Vs/2 and the voltage of the second signal line OUTB is clamped to the ground (t62). Accordingly, the voltage of the output line OUTC is also clamped to Vs/2. Then, at the time t63, the switch SW4 is turned off and the switch SW5 is turned on. With this operation, the electric charge is discharged from the load 20 to the ground through the switches SW3 and SW5, so that the potential of the output line OUTC decreases from +Vs/2 to the ground level.

Then, at the time t64, the switches SW1 and SW3 are turned off and the switch SW2 is turned on. With this operation, the potential of the first signal line OUTA changes to the ground level by the time t65 and the potential of the second signal line OUTB changes to −Vs/2 by the time t65. Accordingly, the potential of the output signal line OUTC decreases to −Vs/2 as in the second signal line OUTB.

By performing the above-described operation, the drive circuit shown in FIG. 20 applies a voltage changing from −Vs/2 to Vs/2 to the common electrode X during the sustaining discharge period. Also, the drive circuit alternately applies voltages (+Vs/2, −Vs/2) having different polarities from the voltage supplied to the common electrodes X to the scan electrodes Y of the respective display lines. Accordingly, the AC-PDP device conducts sustaining discharge.

As shown in FIG. 21, compared with the waveform in the related art shown in FIG. 19, the period T of the ground level which exists in FIG. 19 does not exist at the leading edge of the voltage waveform of the output line OUTC in FIG. 21. In other words, when a sustain operation is carried out under a same period, the drive circuit of this embodiment can lengthen time of sustaining the voltage Vs/2, which is a top width of sustaining discharge pulses, when compared with the related art.

### Sixth Embodiment

Next, a schematic configuration of a drive circuit according to a sixth embodiment, which is a modification of the drive circuit according to the third embodiment shown in FIG. 12, is explained with reference to the drawings.

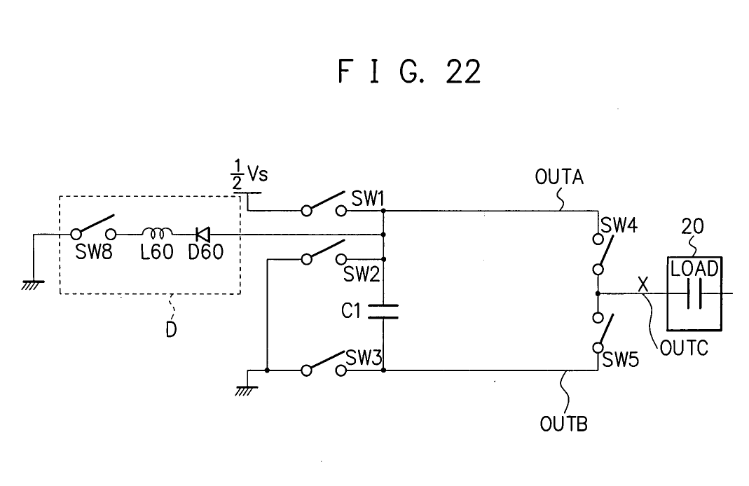

FIG. 22 shows the schematic configuration of the drive circuit according to the sixth embodiment, which is a modification of the drive circuit according to the third embodiment shown in FIG. 12. The drive circuit according to the sixth embodiment shown in FIG. 22 can be applied to, for example, the AC-PDP device (a display device) 1 with the overall configuration shown in FIG. 15 and the configuration of the cell shown in FIGS. 16A to 16C, as in FIG. 12. In FIG. 22, components denoted by the same reference numerals as those in FIG. 12 have the same functions, and therefore an explanation thereof is omitted. Also, in FIG. 22, as in FIG. 12, only a schematic configuration of the X-side circuit is explained. The Y-side circuit has the same structure and operation as the X-side circuit and therefore an explanation is omitted.

The drive circuit according to the sixth embodiment shown in FIG. 22 is different from the drive circuit according to the third embodiment shown in FIG. 12 in the internal configuration of the coil circuit D. Therefore, the configuration of the other part than the coil circuit D in the drive circuit shown in FIG. 22 is not explained.

As shown in FIG. 22, the coil circuit D includes a diode D60, a coil C60, and a switch SW8. A cathode terminal of the diode D60 is connected to a ground through the coil L60 and the switch SW8. An anode terminal of the diode D60 is connected to a node between switches SW1 and SW2. That is, the anode terminal of the diode D60 is connected to a first signal line OUTA.

As a forward direction of the diode D60 indicates, the coil L60 has a discharge function of discharging an electric charge to a load 20 through the switches SW4 and SW8. In other words, the coil L60, the switch SW4, and the load 20 realize a discharge function using L-C resonance to the load 20. The configuration of the coil circuit D is not limited to the above-described configuration, but any circuit is acceptable as long as the circuit includes at least the coil 60 and the coil L60 is configured to carry out discharge by using L-C resonance with the load 20 through the switch SW4.

Although not shown in the figure, a same circuit is connected to the side of the scan electrode Y of the load 20. The switches SW1 to SW5 and SW8 shown in FIG. 22 are controlled by control signals supplied from the drive control circuit 5 shown in FIG. 15. With this configuration, the drive circuit of this embodiment performs sustaining discharge during the sustaining discharge period, when the common electrode X and the scan electrode Y in the cell discharge.

Next, an operation of the drive circuit shown in FIG. 22 is explained.

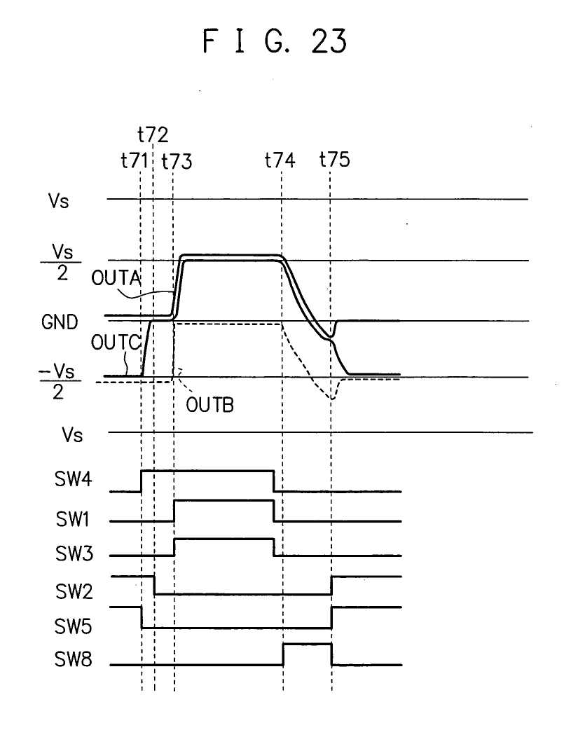

FIG. 23 is a waveform chart showing the operation of the drive circuit shown in FIG. 22. In FIG. 23, voltage waveforms of the first signal line OUTA, the second signal line OUTB, and the output line OUTC are displayed together. Here, these voltage waveforms are aligned with the vertical axis of the waveform of the output line OUTC as a reference. The voltage waveform of the first signal line OUTA is slightly lifted up, and that of the second signal line OUTB is slightly lowered for eye-friendliness so that they do not wrap over the voltage waveform of the output line OUTC.

First, the switch SW4 is turned on and the switch SW5 is turned off in a state that the first signal line OUTA is on the ground level, that the second signal line OUTB and the output line OUTC are at −Vs/2, that the switches SW1, SW3, SW4, and SW8 are turned off, and that the switches SW2 and SW5 are turned on (t71). Accordingly, the output line OUTC is connected to the ground through the switches SW2 and SW4, so that the potential of the output line OUTC increases from −Vs/2 to the ground level.

Then, by turning off the switch SW2 at the time t72 and by turning on the switches SW1 and SW3 at the time t73, the first signal line OUTA increases from the ground level to Vs/2 and the second signal line OUTB increases from −Vs/2 to the ground level. Accordingly, the first signal line OUTA is connected to the output line OUTC, so that the voltage of the output line OUTC increases from the ground level to Vs/2.

Then, by turning off the switches SW1, SW3, and SW4 right before the time t74 and by turning on the switch SW8 at the time t74, L-C resonance is carried out between the coil L60 and the capacitance of the load 20 through the switch SW4. Accordingly, an electric charge is discharged from the load 20 to the ground through the switch SW8, the coil L60, the diode D60, and the switch SW4, so that the potentials of the first signal lint OUTA and the output line OUTC decrease from +Vs/2 toward −Vs/2 via the potential of the ground level. By this electric current flow, the voltage of the output line OUTC applied to the common electrode X gradually decreases as shown in time between t74 and t75 in FIG. 23.

Then, at the time t75, by turning on the switches SW2 and SW5 before reaching a peak voltage appearing in this L-C resonance and by turning off the switch SW8, the voltage of the output line OUTC applied to the common electrode X is clamped to −Vs/2. By performing the above-described operation, the drive circuit shown in FIG. 22 applies a voltage changing from −Vs/2 to Vs/2 to the common electrode X during the sustaining discharge period. Also, the drive circuit alternately applies voltages (+Vs/2, −Vs/2) having different polarities from the voltage supplied to the common electrodes X to the scan electrodes Y of the respective display lines. Accordingly, the AC-PDP device conducts sustaining discharge.

As shown in FIG. 23, compared with the waveform in the related art shown in FIG. 19, the period T of the ground level which exists in FIG. 19 does not exist at the falling edge of the voltage waveform of the output line OUTC in FIG. 23. In other words, when a sustain operation is carried out under a same period, the drive circuit of this embodiment can lengthen time of sustaining the voltage Vs/2, which is a top width of sustaining discharge pulses, when compared with the related art.

### Seventh Embodiment

Next, a schematic configuration of a drive circuit according to a seventh embodiment, which is a modification of the drive circuit according to the second embodiment shown in FIG. 10, is explained with reference to the drawings.

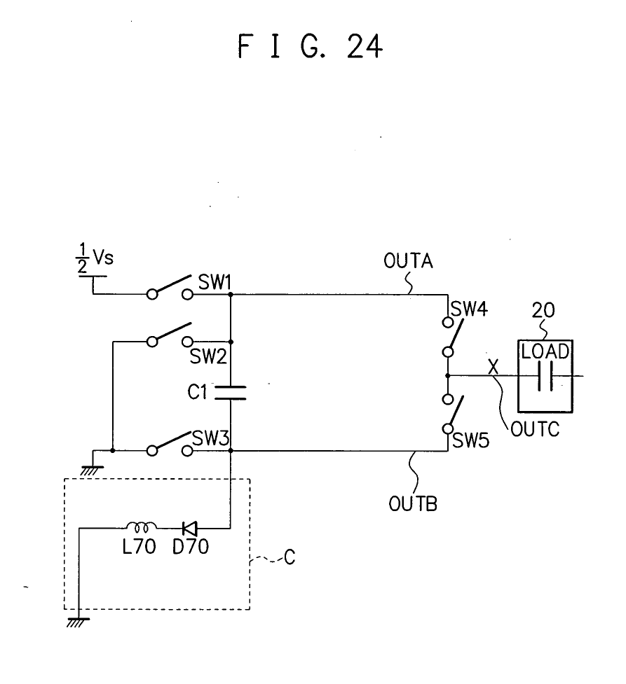

FIG. 24 shows the schematic configuration of the drive circuit according to the seventh embodiment, which is a modification of the drive circuit according to the second embodiment shown in FIG. 10. The drive circuit according to the seventh embodiment shown in FIG. 24 can be applied to, for example, the AC-PDP device (a display device) 1 with the overall configuration shown in FIG. 15 and the configuration of the cell shown in FIGS. 16A to 16C, as the drive circuit shown in FIG. 10. In FIG. 24, components denoted by the same reference numerals as those in FIG. 10 have the same functions, and therefore an explanation thereof is omitted. Also, in FIG. 24, as in FIG. 10, only a schematic configuration of the X-side circuit is explained. The Y-side circuit has the same structure and operation as the X-side circuit and therefore an explanation is omitted.

The drive circuit according to the seventh embodiment shown in FIG. 24 is different from the drive circuit according to the second embodiment shown in FIG. 10 in the internal configuration of the coil circuit C. Therefore, the configuration of the other part than the coil circuit C in the drive circuit shown in FIG. 24 is not explained.

As shown in FIG. 24, the coil circuit C includes a diode D70 and a coil C70. A cathode terminal of the diode D70 is connected to a ground through the coil L70. An anode terminal of the diode D70 is connected to a node between switches SW1 and SW2. That is, the anode terminal of the diode D70 is connected to a second signal line OUTB.

As a forward direction of the diode D70 indicates, the coil L70 has a discharge function of discharging an electric charge to a load 20 through a switch SW5. The configuration of the coil circuit C is not limited to the above-described configuration, but any circuit is acceptable as long as the circuit includes at least the coil 70 and the coil L70 is configured to discharge an electric charge to the load 20 by performing L-C resonance with the load 20.

Although not shown in the figure, a same circuit is connected to the side of the scan electrode Y of the load 20. The switches SW1 to SW5 shown in FIG. 24 are controlled by control signals supplied from the drive control circuit 5 shown in FIG. 15. With this configuration, the drive circuit of this embodiment performs sustaining discharge during the sustaining discharge period, when the common electrode X and the scan electrode Y in the cell discharge.

Next, an operation of the drive circuit shown in FIG. 24 is explained.

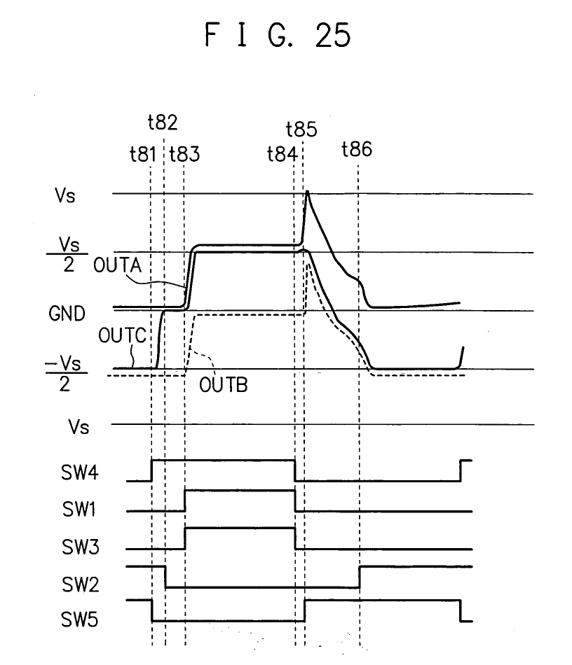

FIG. 25 is a waveform chart showing the operation of the drive circuit shown in FIG. 24. In FIG. 25, voltage waveforms of the first signal line OUTA, the second signal line OUTB, and the output line OUTC are displayed together. Here, these voltage waveforms are aligned with the vertical axis of the waveform of the output line OUTC as a reference. The voltage waveform of the first signal line OUTA is slightly lifted up, and that of the second signal line OUTB is slightly lowered for eye-friendliness so that they do not wrap over the voltage waveform of the output line OUTC.

First, the switch SW4 is turned on and the switch SW5 is turned off in a state that the first signal line OUTA is on the ground level, that the second signal line OUTB and the output line OUTC are at −Vs/2, that the switches SW1, SW3, and SW4 are turned off, and that the switches SW2 and SW5 are turned on (t81). Accordingly, the output line OUTC is connected to the ground through the switches SW2 and SW4, so that the potential of the output line OUTC increases from −Vs/2 to the ground level.

Then, by turning off the switch SW2 at the time t82 and by turning on the switches SW1 and SW3 at the time t83, the first signal line OUTA increases from the ground level to Vs/2 and the second signal line OUTB increases from −Vs/2 to the ground level. Accordingly, the first signal line OUTA is connected to the output line OUTC, so that the voltage of the output line OUTC increases from the ground level to Vs/2.

Then, the switches SW1, SW3, and SW4 are turned off at the time t84. Then, the switch SW5 is turned on at the time t85. With this operation, the voltage Vs/2 stored in the load 20 is supplied to the second signal line OUTB through the switch SW5, so that the voltage of the second signal line OUTB instantaneously changes to Vs/2. As a result, the voltage of the first signal line OUTA instantaneously increases to Vs.

Then, right after the time t85, L-C resonance is carried out between the coil L70 and the capacitance of the load 20 through the switch SW5. Accordingly, an electric charge is discharged from the load 20 to the ground through the diode D70 and the coil L70 of the coil circuit C and the switch SW5, so that the potentials of the second signal line OUTB and the output line OUTC decrease from +Vs/2 toward −Vs/2 via the potential of the ground level. By this electric current flow, the voltage of the output line OUTC applied to the common electrode X gradually decreases as shown in time between t85 and t86 in FIG. 25.

Next, by turning on the switch SW2 before reaching a peak voltage appearing in this resonance, the voltage of the output line OUTC applied to the common electrode X is clamped to −Vs/2 (t86). By performing the above-described operation, the drive circuit shown in FIG. 24 applies a voltage changing from −Vs/2 to Vs/2 to the common electrode X during the sustaining discharge period. Also, the drive circuit alternately applies voltages (+Vs/2, −Vs/2) having different polarities from the voltage supplied to the common electrodes X to the scan electrodes Y of the respective display lines. Accordingly, the AC-PDP device conducts sustaining discharge.

Comparing the waveform shown in FIG. 25 with the waveform in the related art shown in FIG. 19, the period T of the ground level which exists in FIG. 19 does not exist in the voltage waveform of the output line OUTC in FIG. 25. In other words, when a sustain operation is carried out under a same period, the drive circuit of this embodiment can lengthen time of sustaining a voltage Vs/2 or −Vs/2, which are a top width and a bottom width of sustaining discharge pulses, when compared with the related art.

### Eighth Embodiment

Next, a schematic configuration of a drive circuit according to an eighth embodiment, which is a modification of the drive circuit according to the second embodiment shown in FIG. 10, is explained with reference to the drawings.

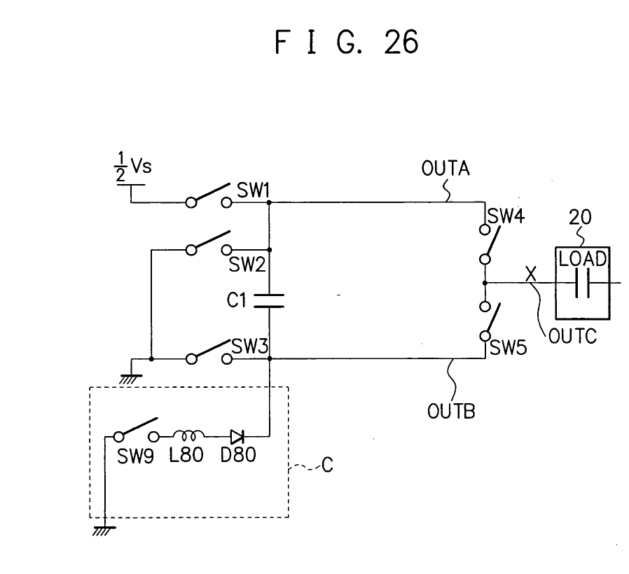

FIG. 26 shows the schematic configuration of the drive circuit according to the eighth embodiment, which is a modification of the drive circuit according to the second embodiment shown in FIG. 10. The drive circuit according to the eighth embodiment shown in FIG. 26 can be applied to, for example, the AC-PDP device (a display device) 1 with the overall configuration shown in FIG. 15 and the configuration of the cell shown in FIGS. 16A to 16C, as the drive circuit shown in FIG. 10. In FIG. 26, components denoted by the same reference numerals as those in FIG. 10 have the same functions, and therefore an explanation thereof is omitted. Also, in FIG. 26, as in FIG. 10, only a schematic configuration of the X-side circuit is explained. The Y-side circuit has the same structure and operation as the X-side circuit and therefore an explanation is omitted.

The drive circuit according to the eighth embodiment shown in FIG. 26 is different from the drive circuit according to the second embodiment shown in FIG. 10 in the internal configuration of the coil circuit C. Therefore, the configuration of the other part than the coil circuit C in the drive circuit shown in FIG. 26 is not explained.

As shown in FIG. 26, the coil circuit C includes a diode D80, a coil C80, and a switch SW9. An anode terminal of the diode D80 is connected to a ground through the coil L80 and the switch SW9. A cathode terminal of the diode D80 is connected to a node between a capacitor C1 and a switch SW3. That is, the cathode terminal of the diode D80 is connected to a second signal line OUTB.

As a forward direction of the diode D80 indicates, the coil L80 has a charge function of supplying an electric charge to a load 20 through a switch SW5. The configuration of the coil circuit C is not limited to the above-described configuration, but any circuit is acceptable as long as the circuit includes at least the coil 80 and the coil L80 is configured to supply an electric charge to the load 20 by performing L-C resonance with the load 20.

Although not shown in the figure, a same circuit is connected to the side of the scan electrode Y of the load 20. The switches SW1 to SW5 and the switch SW9 shown in FIG. 26 are controlled by control signals supplied from the drive control circuit 5 shown in FIG. 15. With this configuration, the drive circuit of this embodiment performs sustaining discharge during the sustaining discharge period, when the common electrode X and the scan electrode Y in the cell discharge.

Next, an operation of the drive circuit shown in FIG. 26 is explained.

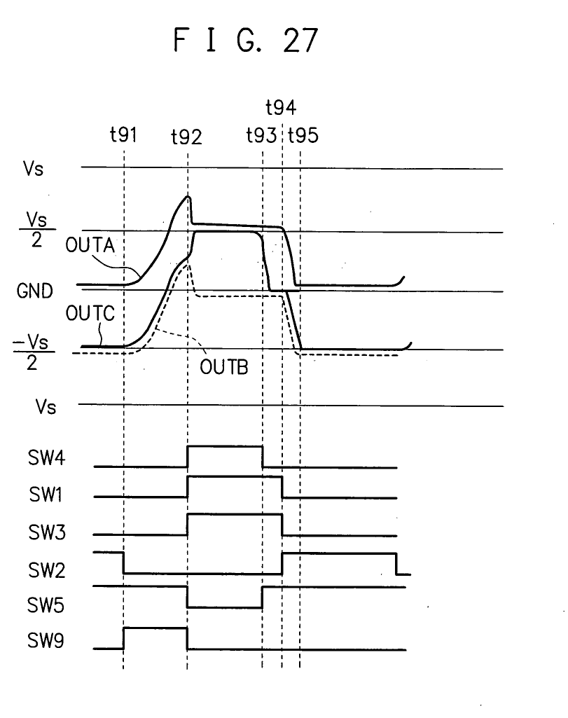

FIG. 27 is a waveform chart showing the operation of the drive circuit shown in FIG. 26. In FIG. 27, voltage waveforms of the first signal line OUTA, the second signal line OUTB, and the output line OUTC are displayed together. Here, these voltage waveforms are aligned with the vertical axis of the waveform of the output line OUTC as a reference. The voltage waveform of the first signal line OUTA is slightly lifted up, and that of the second signal line OUTB is slightly lowered for eye-friendliness so that they do not wrap over the voltage waveform of the output line OUTC.

First, the switch SW2 is turned off and the switch SW9 is turned on in a state that the first signal line OUTA is on the ground level, that the second signal line OUTB and the output line OUTC are at −Vs/2, that the switches SW1, SW3, SW4, and SW9 are turned off, and that the switches SW2 and SW5 are turned on (t91). Accordingly, the voltage at the terminal on the switch SW3 side of the capacitor C1 starts to change toward the ground level. In other words, L-C resonance is carried out between the coil L80 and the capacitance of the load 20 through the switch SW5, so that an electric charge is supplied from the ground to the load 20 through the coil L80, the diode D80, and the switch SW5. Accordingly, the potentials of the second signal line OUTB and the output line OUTC increase from −Vs/2 toward +Vs/2 via the potential of the ground level. By this electric current flow, the voltage of the output line OUTC applied to the common electrode X gradually increases as shown in time between t91 and t92 in FIG. 27.

Then, at the time t92, the switches SW5 and SW9 are turned off and the switches SW1, SW3, and SW4 are turned on before reaching a peak a voltage appearing in this L-C resonance, so that the voltage of the first signal line OUTA changes to Vs/2 and the voltage of the second signal line OUTB changes to the ground level. Also, the voltage of the output line OUTC changes to Vs/2 according to the change in the first signal line OUTA. That is, when the voltage of the first signal line OUTA is clamped to Vs/2, the voltage of the output line OUTC is clamped accordingly.

Then, at the time t93, the switch SW4 is turned off and the switch SW5 is turned on. With this operation, an electric charges is discharged from the load 20 to the ground through the switches SW3 and SW5, so that the potential of the output line OUTC decreases from +Vs/2 to the ground level.

Then, at the time 94, the switches SW1 and SW3 are turned off and the switch SW2 is turned on. With this operation, the potential of the first signal line OUTA is changed to the ground level by the time t95 and the potential of the second signal line OUTB changes to −Vs/2 by the time t95. Accordingly, the potential of the output line OUTC decreases to −Vs/2 as in the second signal line OUTB.

With the above-described operation, the drive circuit shown in FIG. 26 applies a voltage changing from −Vs/2 to Vs/2 to the common electrode X during the sustaining discharge period. Also, the drive circuit alternately applies voltages (+Vs/2, −Vs/2) having different polarities from the voltage supplied to the common electrodes X to the scan electrodes Y of the respective display lines. Accordingly, the AC-PDP device conducts sustaining discharge.

As shown in FIG. 27, compared with the waveform in the related art shown in FIG. 19, the period T of the ground level which exists in FIG. 19 does not exist at the leading edge of the voltage waveform of the output line OUTC in FIG. 27. In other words, when a sustain operation is carried out under a same period, the drive circuit of this embodiment can lengthen time of sustaining a voltage Vs/2, which is a top width of sustaining discharge pulses, when compared with the related art.

### Modification of the First Embodiment

Next, a modification of the drive circuit according to the first embodiment shown in FIG. 2 is explained with reference to the drawings.

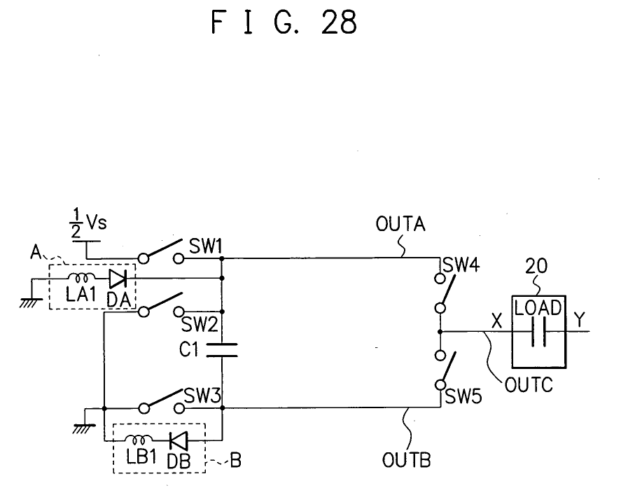

FIG. 28 shows the modification of the drive circuit according to the first embodiment shown in FIG. 2. The drive circuit shown in FIG. 28 can be applied to, for example, the AC-PDP device (a display device) 1 with the overall configuration shown in FIG. 15 and the configuration of the cell shown in FIGS. 16A to 16C, as the drive circuit shown in FIG. 2. Also, in FIG. 28, as in FIG. 2, only a schematic configuration of the X-side circuit is explained. The Y-side circuit has the same structure and operation as the X-side circuit and therefore an explanation is omitted.

The drive circuit shown in FIG. 28 is different from the drive circuit according to the first embodiment shown in FIG. 2 in that the coil LA is replaced with a coil LA1 and that the coil LB is replaced with a coil LB1. Specifically, the inductances of the coils LA and LB are equal in the drive circuit according to the first embodiment shown in FIG. 2, whereas the inductances of the coils LA1 and LB1 are LA1>LB1 or LA1<LB1. An explanation of the other part of the drive circuit shown in FIG. 28 is omitted.

Next, an operation of the drive circuit shown in FIG. 28 is explained. First, an operation of the drive circuit when a relationship in inductance between the coils LA1 and LB1 is LA1>LB1 is explained.

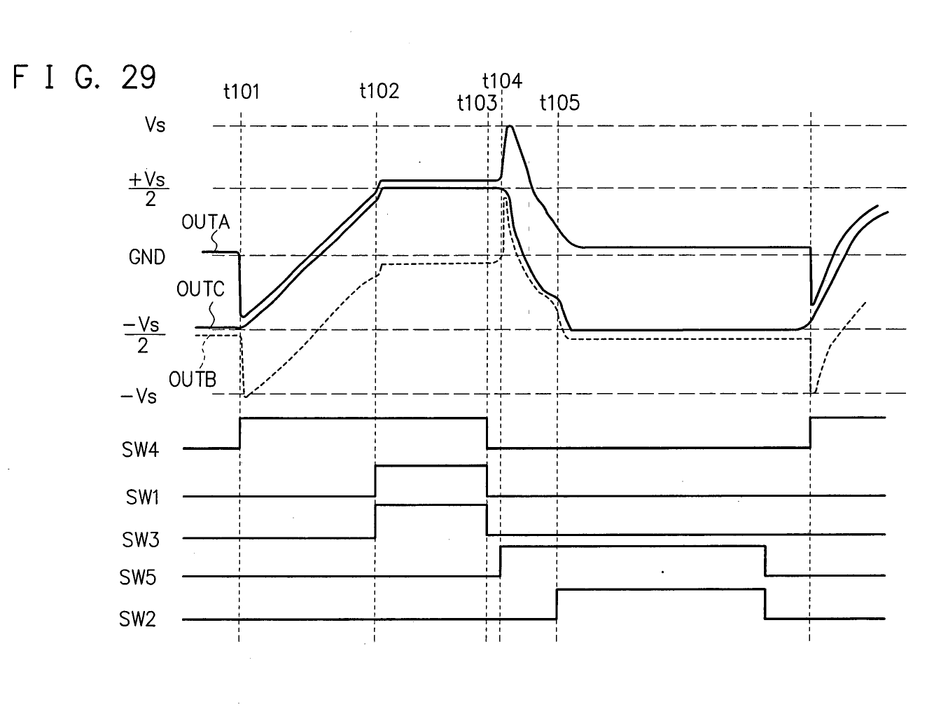

FIG. 29 is a waveform chart showing the operation of the drive circuit shown in FIG. 28 when the relationship in inductance between the coils LA1 and LB1 is LA1>LB1. The outline of the operation during time between t101 to t105 shown in FIG. 29 is the same as that of the operation during time between t11 to t15 shown in FIG. 3, and thus the corresponding explanation is omitted. The operation shown in FIG. 29 is different from that shown in FIG. 3 in that the time period from t101 to t102 is long and that the maximum voltage reached by L-C resonance is high. In other words, since the inductance of the coil LA1 connected to the first signal line OUTA is high, the rise time of L-C resonance is longer, but the maximum voltage at the rising is higher. Accordingly, when the switch SW1 is turned on under this state, power consumption required for clamping the voltages of the first signal line OUTA and the output line OUTC to Vs/2 can be reduced.

Next, an operation of the drive circuit when a relationship in inductance between the coils LA1 and LB1 is LA1<LB1 is explained.

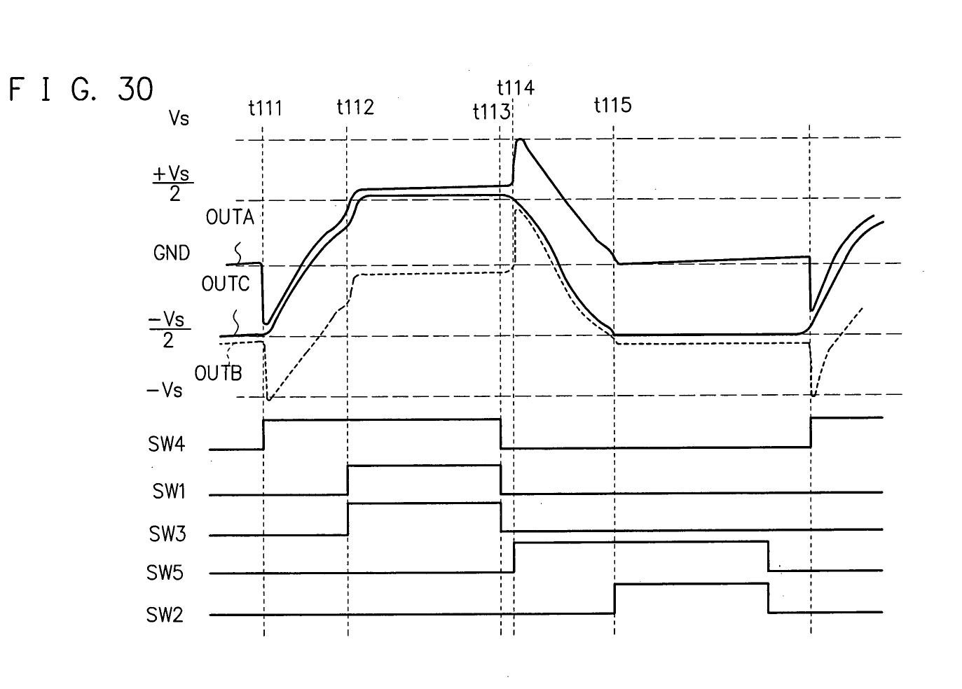

FIG. 30 is a waveform chart showing the operation of the drive circuit shown in FIG. 28 when the relationship in inductance between the coils LA1 and LB1 is LA1<LB1. The outline of the operation during time between t111 to t115 shown in FIG. 30 is the same as that of the operation during time between t11 to t15 shown in FIG. 3, and thus the corresponding explanation is omitted. The operation shown in FIG. 30 is different from that shown in FIG. 3 in that the time period from t114 to t115 is long and that the maximum voltage reached by L-C resonance during the time period is high. In other words, since the inductance of the coil LB1 connected to the second signal line OUTB is high, the fall time of L-C resonance is longer, but the range of variation in the voltage during the fall time by L-C resonance is wider. Accordingly, when discharge is performed during the sustaining discharge period, power consumption required for clamping the voltage of the output line OUTC to −Vs/2 can be reduced by widening the range of variation in the voltage using L-C resonance rather than by shortening the fall time of the voltage of the output line OUTC.

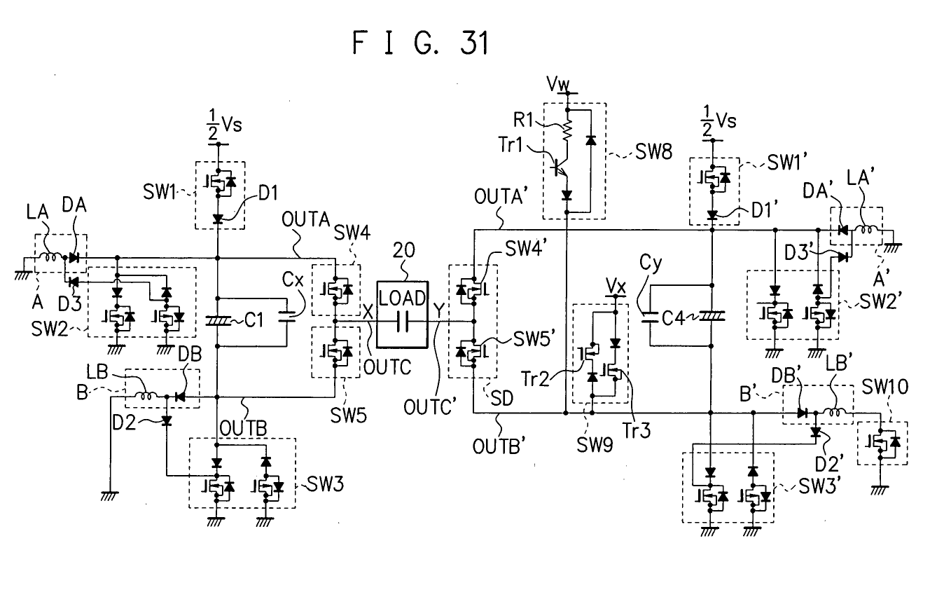

Next, a modification of the specific example (including the scan electrode Y side) of the drive circuit of FIG. 2 shown in FIG. 4 is explained with reference to FIG. 31. FIG. 31 shows the modification of the specific example (including the scan electrode Y side) of the drive circuit of FIG. 2 shown in FIG. 4. The difference from the circuit shown in FIG. 4 is that a diode D3 is added in the X-side circuit and that the point to which the cathode terminal of the diode D2 is connected is changed. Specifically, a node between the coil LA and the diode DA is connected to a cathode terminal of the diode D3. A drain terminal of a p-type MOSFET forming the switch SW2 is connected to an anode terminal of the diode D3. An anode terminal of the diode D2 is connected to a drain terminal of an n-type MOSFET of the switch SW3. On the other hand, in the Y-side circuit, a diode D3′ is simply added in the same manner as in the X-side circuit. With this configuration, noise generated in the first signal lint OUTA can be suppressed.

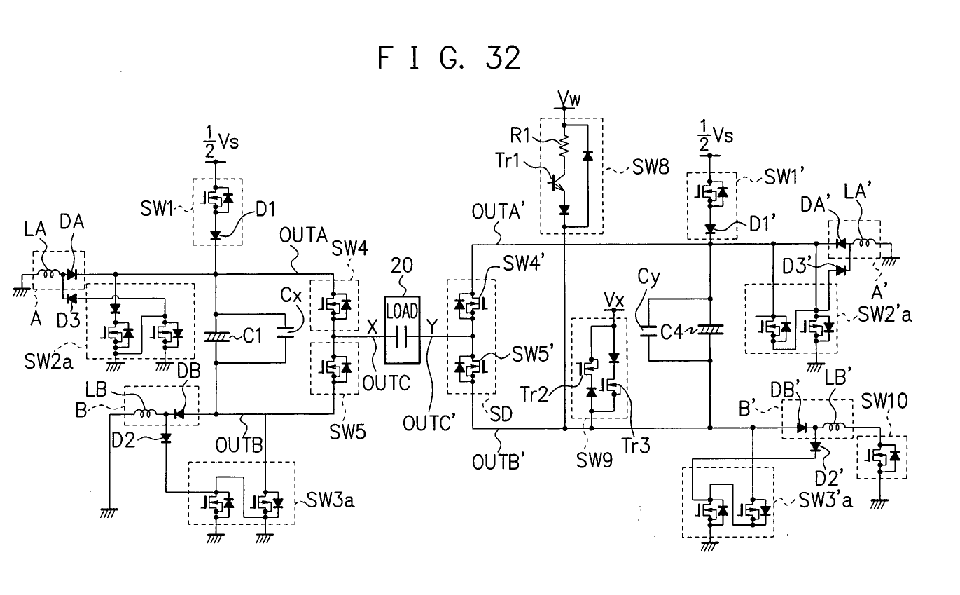

Next, another modification, in which the configuration is partly different from that of the modification of the specific example of the drive circuit of FIG. 2 shown in FIG. 31, is explained with reference to FIG. 32. FIG. 32 shows another modification of the specific example (including the scan electrode Y side) of the drive circuit of FIG. 2 shown in FIG. 4. The difference between FIGS. 31 and 32 is that the switches SW2, SW2′, SW3, and SW3′ in FIG. 31 are replaced with switches SW2a, SW2′a, SW3a, and SW3′a in FIG. 32, which are differently configured from those in FIG. 31. Hereinafter, only a part different from FIG. 31 is explained.

As shown in FIG. 32, each of the switches SW2a, SW2′a, SW3a, and SW3′a consists of a p-type MOSFET and an n-type MOSFET. In the switch SW2a, an n-type. MOSFET and a p-type MOSFET are connected in series between the first signal line OUTA and the ground (the p-type MOSFET is on the ground side). A node between the n-type MOSFET and the p-type MOSFET is connected to the anode terminal of the diode D3. Likewise, in the switch SW2′a, an n-type MOSFET and a p-type MOSFET are connected in series between a third signal line OUTA′ and the ground (the p-type MOSFET is on the ground side). A node between the n-type MOSFET and the p-type MOSFET is connected to the anode terminal of the diode D3′.

In the switch SW3a, a p-type MOSFET and an n-type MOSFET are connected in series between the second signal line OUTB and the ground (the n-type MOSFET is on the ground side). A node between the p-type MOSFET and the n-type MOSFET is connected to the cathode terminal of the diode D2. Likewise, in the switch SW3′a, a p-type MOSFET and an n-type MOSFET are connected in series between a fourth signal line OUTB′ and the ground (the n-type MOSFET is on the ground side). A node between the p-type MOSFET and the n-type MOSFET is connected to the cathode terminal of the diode D2′. As described above, the number of diodes in the circuit configuration shown in FIG. 32 is smaller than that in FIG. 31, so that the number of components can be advantageously reduced.

Alternatively, each of the switches SW2a, SW2′a, SW3a, and SW3′a shown in FIG. 32 may consist of two n-type MOSFETs. Specifically, in the respective four switches, the source terminals of two n-type MOSFETs are connected to each other, the drain terminals of one of the n-type MOSFETs are connected to the first to fourth signal lines, respectively, and the drain terminals of the other n-type MOSFET are connected to the ground. When the switches SW2a, SW2′a, SW3a, and SW3′a are configured like this, the same function and effect in the configuration shown in FIG. 32 can be obtained.

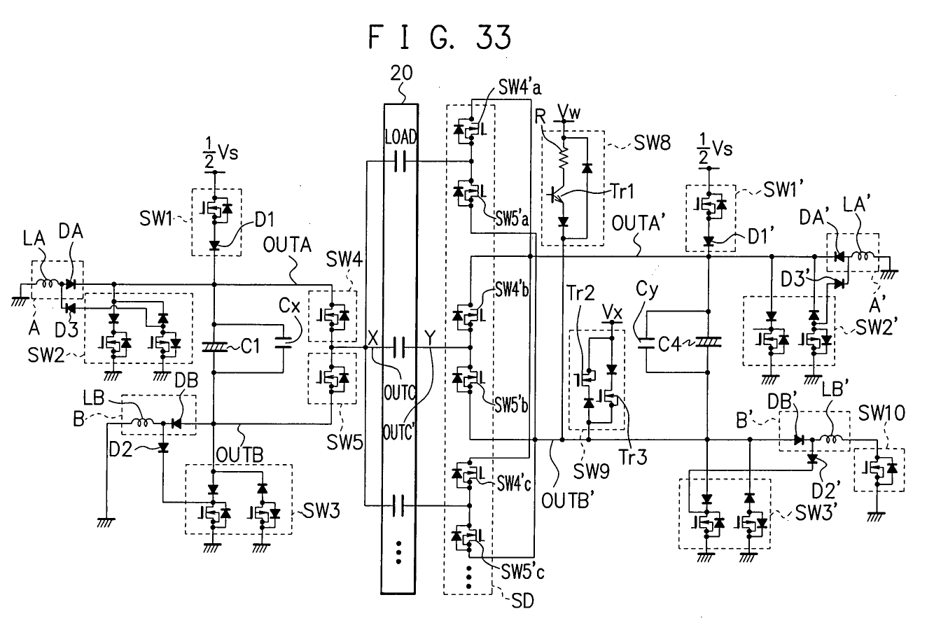

Next, an example of a more specific configuration of the switches SW4′ and SW5′ and the load 20 in the specific drive circuit shown in FIG. 31 is explained. FIG. 33 shows an example of a more specific configuration of the switches SW4′ and SW5′ and the load 20 in the specific drive circuit shown in FIG. 31. As shown in FIG. 33, in the Y-side circuit, pairs of switches SW4′x and SW5′x (x is a, b, c, switches SW4′a and SW5′a; switches SW4′b and SW5′b; switches SW4′c and SW5′c; . . . are provided for the respective cells (load 20). Herein, the cells correspond to the pixels shown in FIG. 15.

Next, an operation of the drive circuit shown in FIG. 31 is explained. In particular, an operation in an address period and a sustaining discharge period in one subfield is explained. In an address period, when a voltage is to be applied to a scan electrode Y corresponding to a display line, the switches SW4′ and SW5′ are controlled in the scan electrode Y which has been line-sequentially selected. Accordingly, a voltage of (−Vs/2) level is applied to the scan electrode Y and a voltage of the ground level is applied to non-selected scan electrodes Y.

Specifically, by turning on the switch SW1′, a voltage Vs/2 is accumulated in the capacitor C4. Then, by turning off the switch SW1′ and turning on the switch SW2′, the potential of an upper portion of the capacitor C4 changes to the ground level and that of a lower portion thereof changes to −Vs/2. Then, by turning on the switch SW5′, a voltage −Vs/2 is supplied to the scan electrode Y. In order to change the potential of the scan electrode Y to the ground level, the switches SW4′ and SW2′ are turned on at the same time.

Then, in the sustaining discharge period, voltages (−Vs/2, Vs/2) are alternately applied to all of the scan electrodes Y by controlling all of the switches SW4′ and SW5′, so that sustaining discharge is performed. Alternatively, the voltages (−Vs/2, Vs/2) may alternately be applied to some of the scan electrodes Y by controlling some of the switches SW4′ and SW5′.

As described above, the switches SW4′ and SW5′ are used both for selectively applying a voltage to the scan electrode Y during the address period and for applying a voltage to the scan electrode Y during the sustaining discharge period. In the known art, separate switches are provided for the respective purposes. By using common switches in each cell as in this embodiment, the number of switches can be reduced advantageously.

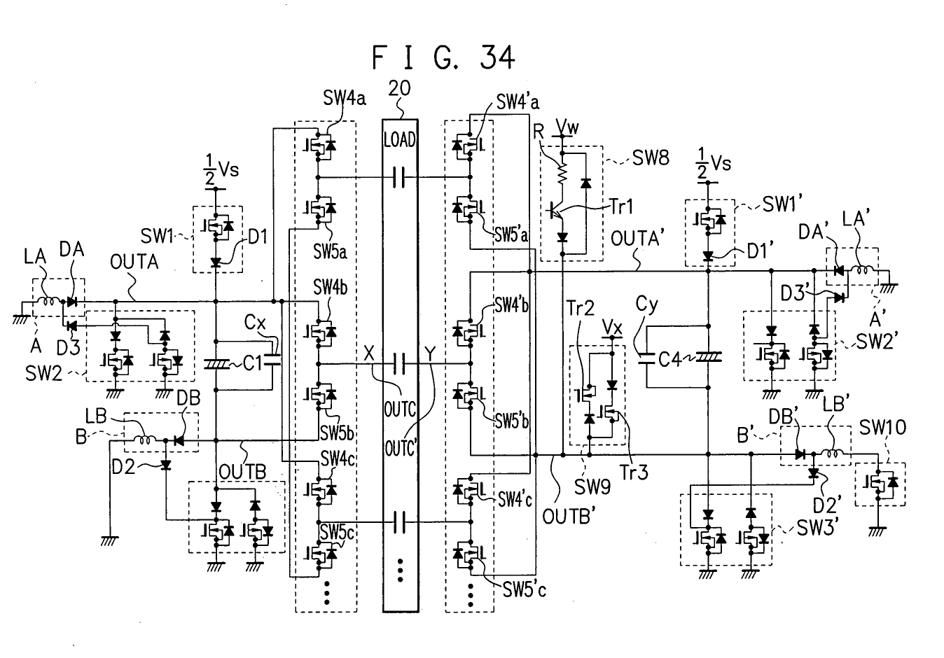

Next, a modification of the specific drive circuit shown in FIG. 33 is explained. FIG. 34 is the modification of the specific circuit shown in FIG. 33. As shown in FIG. 34, pairs of switches SW4x and SW5x (x is a, b, c, . . . ) may be provided for the respective cells (load 20) in the X-side circuit as well as in the Y-side circuit. With this configuration shown in FIG. 33, each of the electrodes X and Y can be controlled independently from each other unlike in a case where the X-side electrode is a common electrode. That is, this configuration allows complicated control to be realized.

### Ninth Embodiment

Next, a schematic configuration of a drive circuit according to a ninth embodiment, which is a modification of the specific drive circuit according to the first embodiment shown in FIG. 4, is explained with reference to the drawings.

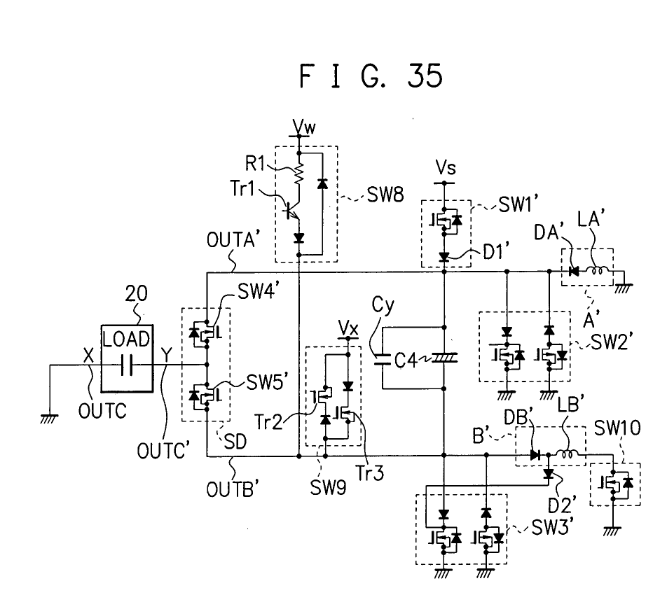

FIG. 35 shows the schematic configuration of the drive circuit according to the ninth embodiment, which is a modification of the drive circuit according to the first embodiment shown in FIG. 4. The drive circuit according to the ninth embodiment shown in FIG. 35 can be applied to, for example, the AC-PDP device (a display device) 1 with the overall configuration shown in FIG. 15 and the configuration of the cell shown in FIGS. 16A to 16C, as the drive circuit shown in FIG. 4. In FIG. 35, components denoted by the same reference numerals as those in FIG. 4 have the same functions, and therefore an explanation thereof is omitted.

The drive circuit according to the ninth embodiment shown in FIG. 35 is different from the drive circuit according to the first embodiment shown in FIG. 4 in that the X-side circuit does not exist and that a voltage Vs is applied to the switch SW1′. An explanation of the other part of the drive circuit shown in FIG. 35 is omitted.

Next, an operation of the drive circuit shown in FIG. 35 is explained.

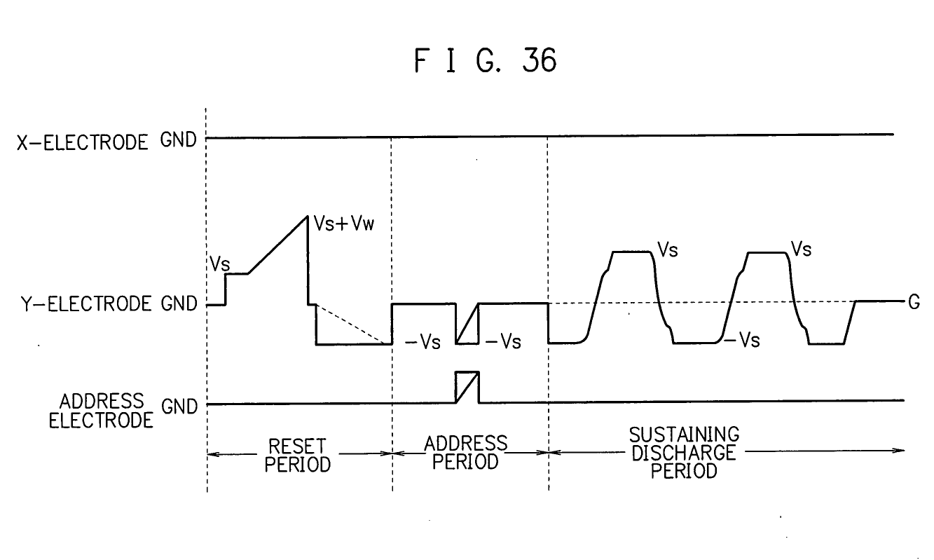

FIG. 36 is a waveform chart showing the operation of the drive circuit shown in FIG. 35. FIG. 36 shows an example of waveforms of voltages applied to an X-electrode, a Y-electrode, and an address electrode of one subfield among a plurality of subfields forming one frame. As described above with reference to FIG. 17, one subfield consists of a reset period consisting of a total write period and a total erase period, an address period, and a sustaining discharge period.

As shown in FIG. 36, also as is clear from FIG. 35, the voltage of the X-electrode is fixed to the ground level. In the reset period, a sum of voltages Vw and Vs is applied to the scan electrode Y. At this time, the voltage Vs+Vw gradually increases as time passes. Accordingly, the potential difference between the common electrode X and the scan electrode Y becomes Vs+Vw. Then, discharge is performed in all of the cells in all of the display lines regardless of the previous display state, so that a wall charge is generated (total write).

Then, after the voltage of the scan electrode Y is returned to the ground level, the voltage applied to the scan electrode Y is decreased to −Vs. Accordingly, the voltage of the wall charge exceeds a firing potential so as to start discharge in all of the cells. At the same time, the accumulated wall charge is erased (total erase).

Then, in the address period, address discharge is performed line-sequentially in order to turn on/off each cell according to display data. When a voltage is to be applied to a scan electrode Y corresponding to a display line, a voltage on a −Vs level is applied to the line-sequentially selected scan electrode Y and a voltage on the ground level is applied to non-selected scan electrodes Y.

At this time, an address pulse of a voltage of Va is selectively applied to an address electrode Aj corresponding to a cell to cause sustaining discharge among the address electrodes A1 to Am, that is, a cell to be lighted.

After that, in the sustaining discharge period, the voltage of the scan electrode Y gradually increases after reached −Vs. At this time, part of the charge is discharged from the power recovery circuit including the coil LA′. Then, the voltage of the scan electrode Y is clamped to Vs after exceeding the ground level and before reaching a peak of the increase.

When the voltage applied to the scan electrode Y is to be decreased from Vs to −Vs, the applied voltage is gradually decreased and part of the charge accumulated in the cell is recovered to the power recovery circuit. In this way, during the sustaining discharge period, voltages (+Vs, −Vs) are alternately applied to the scan electrode Y so as to perform sustaining discharge, thereby displaying an image of one subfield.

Next, a modification of the drive circuit according to the ninth embodiment shown in FIG. 35 is explained.

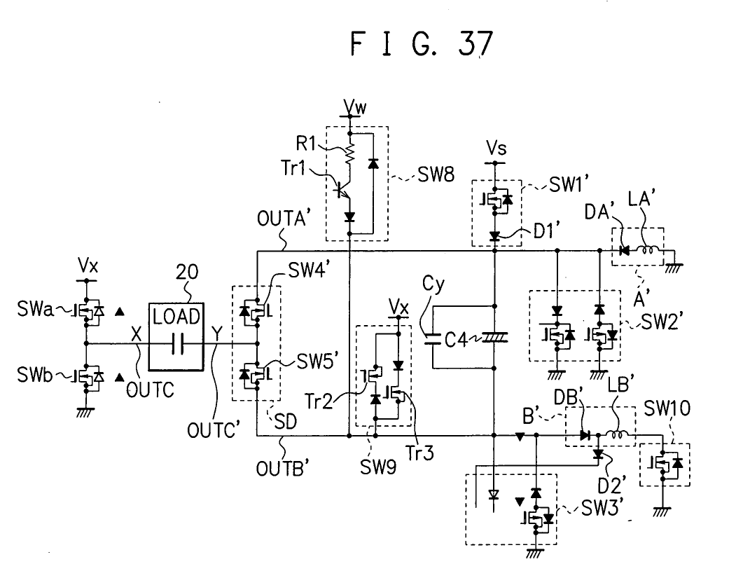

FIG. 37 shows the modification of the drive circuit according to the ninth embodiment shown in FIG. 35. The drive circuit shown in FIG. 37 is different from the drive circuit according to the ninth embodiment shown in FIG. 35 in that switches SWa and SWb are provided in the X-side circuit. An explanation of the other part of the configuration shown in FIG. 37 is omitted. Additionally, in the X-side circuit, the switches SWa and SWb are connected in series between a power supply for supplying a voltage Vx and the ground. A node between the switches SWa and SWb is connected to the X-electrode of the load 20 through the output line OUTC.

Next, an operation of the drive circuit shown in FIG. 37 is explained.

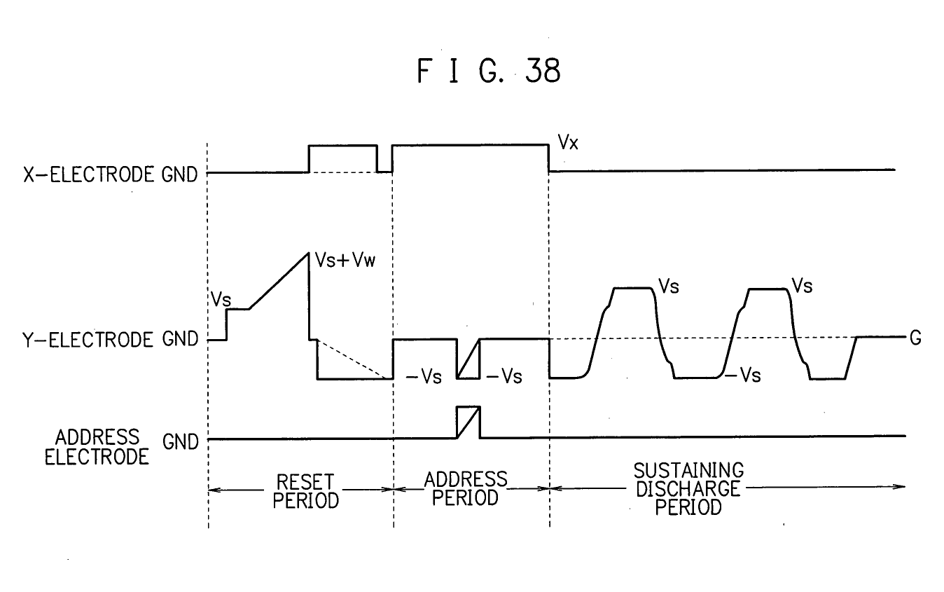

FIG. 38 is a waveform chart showing the operation of the drive circuit shown in FIG. 37. As FIG. 36, FIG. 38 shows an example of waveforms of voltages applied to the X-electrode, the Y-electrode, and the address electrode of one subfield among a plurality of subfields forming one frame. In FIG. 38, a part different from FIG. 36 is the waveform of a voltage Vx applied to the X-electrode during the reset period and the address period. Hereinafter, the difference is explained.

As shown in FIG. 38, in the reset period, the voltage of the common electrode X is on the ground level first. A sum of voltages Vw and Vs is applied to the scan electrode Y. At this time, the voltage Vs+Vw gradually increases as time passes. Accordingly, the potential difference between the common electrode X and the scan electrode Y becomes Vs+Vw. Then, discharge is performed in all of the cells in all of the display lines regardless of the previous display state, so that a wall charge is generated (total write).

Then, after the voltage of the scan electrode Y is returned to the ground level, a voltage Vx is applied to the common electrode X and the voltage applied to the scan electrode Y is decreased to −Vs. Accordingly, the voltage of the wall charge exceeds a firing potential so as to start discharge in all of the cells. At the same time, the accumulated wall charge is erased (total erase). In this embodiment, the voltage Vx may either be a positive voltage or a negative voltage as long as it is appropriate for total erase.

Then, in the address period, address discharge is performed line-sequentially in order to turn on/off each cell according to display data. When a voltage is to be applied to a scan electrode Y corresponding to a display line, a voltage on a −Vs level is applied to the line-sequentially selected scan electrode Y and a voltage on the ground level is applied to non-selected scan electrodes Y. On the other hand, a voltage Vx is applied to the common electrode X. In this case, too, the value of the voltage Vx is not specified as long as it is appropriate for causing sustaining discharge.

The operation during the sustaining discharge period is the same as that in FIG. 36, and an explanation thereof is omitted.

The embodiments of the present invention are explained in detail with reference to the drawings. However, specific configurations are not limited to the above, and any design and so forth without departing from the spirit of the present invention are included therein.

### Industrial Applicability

As explained above, the drive circuit according to the present invention is a matrix-type flat panel display device for applying a predetermined voltage to a capacitive load being a display cell, and the drive circuit includes a first signal line supplying a first electric potential to one terminal of the capacitive load, a second signal line supplying a second electric potential different from the first electric potential to the other terminal of the capacitive load, and a coil circuit connected between at least either the first signal line or the second signal line and a ground. The coil circuit is a circuit configured with, for example, a coil and a diode, and the coil is connected so as to carry out L-C resonance with the capacitive load through a switch. Accordingly, the coil circuit has a charge function for supplying an electric charge to the capacitive load by L-C resonance between the coil circuit and the capacitive load, and a discharge function for emitting the electric charge to the capacitive load. A power recovery operation is realized by the charge function and the discharge function.

As described above, according to the drive circuit of the present invention, a capacitor exclusively for power recovery is not required, and a circuit (a voltage supervisory circuit or the like) required for the capacitor is not required; thereby an effect of eliminating the number of circuits can be obtained. By adopting resonance between the capacitive load and the coil, a rate of change of the voltage applied from a power element to the capacitive load can be increased. Accordingly, time required for processing of switching an output potential of the power element can be shortened. As described above, time for wall charges to move can be more absolutely secured during the sustaining discharge period. Furthermore, the drive circuit of this embodiment carries out sustaining discharge more stably while securing the same sustain time as the related arts; thereby an enlargement of an operation margin, an improvement of luminance of the panel P, and the like can be expected.

1. A drive circuit of a matrix-type flat panel display device for applying a voltage to a capacitive load being a display cell, the drive circuit comprising:
a first signal line supplying a first electric potential to one terminal of the capacitive load;
a second signal line supplying a second electric potential different from the first electric potential to one terminal of the capacitive load; and
a coil circuit or coil circuits connected between at least either said first signal line or said seq signal line and a supply line supplying a third electric potential,
wherein the first electric potential is supplied from said first signal line after supplying the third electric potential to said second signal line, and the second electric potential is supplied from said second signal line after supplying the third electric potential to said first signal line.

2. The drive circuit according to claim 1, wherein the third electric potential is a ground level.

3. The drive circuit according to claim 1, further comprising:
a first switch controlling a connection between one terminal of the capacitive load and said first signal line; and
a second switch controlling a connection between one terminal of the capacitive load and said second signal line,
wherein at least one of said coil circuits is connected serially to the first switch or the second switch.

4. The drive circuit according to claim 1,
wherein said coil circuit is configured with a coil and a switch.

5. The drive circuit according to claim 1,
wherein said coil circuit is configured with a coil and a diode.

6. The drive circuit according to claim 5,
wherein said coil circuit further includes a switch.

7. The drive circuit according to claim 1,
wherein said coil circuit includes a coil, a diode, and a switch, all being serially connected.

8. The drive circuit according to claim 5,
wherein the coil is connected to said first signal line or said second signal line through the diode.

9. The drive circuit according to claim 5,
wherein the coil is connected directly to said first signal line or said second signal line.

10. The drive circuit according to claim 5,
wherein the coil is connected directly to the ground.

11. The drive circuit according to claim 1,
wherein said coil circuit includes a charge circuit supplying an electric charge to the capacitive load through said second signal line, and a discharge circuit discharging the electric charge to the capacitive load through said second signal line, being connected to said second signal line.

12. The drive circuit according to claim 1,
wherein said coil circuit includes a charge circuit supplying an electric charge to the capacitive load through said second signal line, being connected to said second signal line, and a discharge circuit discharging the electric charge to the capacitive load through said first signal line, being connected to said first signal line.

13. The drive circuit according to claim 1,
wherein said coil circuit includes a charge circuit supplying an electric charge to the capacitive load through said first signal line, being connected to said first signal line, and a discharge circuit discharging the electric charge to the capacitive load through said second signal line, being connected to said second signal line.

14. A drive circuit of a matrix-type flat panel display device for applying a voltage to a capacitive load being a display cell, the drive circuit comprising:
a first switch and a second switch connected serially between a first power supply supplying a first electric potential and a second electric potential, and a second power supply supplying a third electric potential;
a capacitor, one terminal thereof being connected between said first switch and said second switch;
a third switch connected between the other terminal of said capacitor and the second power supply;
a first signal line supplying the first electric potential, being connected to one terminal of said capacitor;
a second signal line supplying the second electric potential different from the first electric potential, being connected to the other terminal of said capacitor; and
a coil circuit or coil circuits connected between at least either said first signal line or said second signal line and the second power supply.

15. A drive method using a drive circuit of a matrix-type flat panel display device for applying a voltage to a capacitive load being a display cell, said drive circuit comprising:
a first signal line supplying a first electric potential to one terminal of the capacitive load;
a second signal line supplying a second electric potential different from the first electric potential to one terminal of the capacitive load;
a coil circuit including a coil connected to at least either said first signal line or said second signal line;
a first switch controlling a connection between one terminal of the capacitive load and said first signal line;
a second switch controlling a connection between one terminal of the capacitive load and said second signal line; and
a third switch controlling a connection between a first power line supplying the first electric potential to the first signal line and the first signal line, said drive method comprising the steps of:
turning on said third switch after the coil and the capacitive load resonate by turning on said first switch.

16. A drive method using a drive circuit of a matrix-type flat panel display device for applying a voltage to a capacitive load being a display cell, said drive circuit comprising:
a first signal line supplying a first electric potential to one terminal of the capacitive load;
a second signal line supplying a second electric potential different from the first electric potential to one terminal of the capacitive load;
a coil circuit including a coil connected to at least either said first signal line or said second signal line;
a first switch controlling a connection between one terminal of the capacitive load and said first signal line;
a second switch controlling a connection between one terminal of the capacitive load and said second signal line; and
a third switch controlling a connection between a second power line supplying said second electric potential to said second signal line and said second signal line, said drive method comprising the steps of:
turning on said third switch after the coil and the capacitive load resonate by turning on said second switch.

17. The drive circuit according to claim 1, wherein the coil circuit connected to the first signal line is defined as a first coil circuit and the coil circuit connected to the second signal line is defined as a second coil circuit, coils of the first and second coil circuits having different inductances.

18. A drive circuit of a matrix-type flat panel display device for applying a voltage to a capacitive load being a display cell, the drive circuit comprising:
a first signal line supplying a first electric potential to one terminal of the capacitive load;
a second signal line supplying a second electric potential different from the first electric potential to one terminal of the capacitive load;
a coil circuit including a coil connected to at least one of the first and second signal lines;
a first switch controlling a connection between one terminal of the capacitive load and the first signal line;
a second switch controlling a connection between one terminal of the capacitive load and the second signal line; and
a third switch controlling a connection between a first power line supplying the first electric potential to the first signal line and the first signal line.

19. The drive circuit according to claim 18, wherein, when the capacitive load comprises a plurality of capacitive loads each corresponding to one pixel of the display cell, pairs of the first and second switches are independently provided at said one terminal of the plurality of capacitive loads, the respective first switches being connected to the first signal line as a common signal line and the respective second switches being connected to the second signal line as a common signal line.

20. The drive circuit according to claim 19, further comprising:
a third signal line supplying the first electric potential to a terminal other than said one terminal of the capacitive load;
a fourth signal line supplying the second electric potential to said the other terminal of the capacitive load;
a coil circuit including a coil connected to at least one of the third and fourth signal lines;
a fourth switch controlling a connection between said the other terminal of the capacitive load and the third signal line; and
a fifth switch controlling a connection between said the other terminal of the capacitive load and the fourth signal line,
wherein pairs of the fourth and fifth switches are independently provided at said the other terminal of the plurality of capacitive loads, the respective fourth switches being connected to the third signal line as a common signal line and the respective fifth switches being connected to the fourth signal line as a common signal line.

21. The drive circuit according to claim 19, wherein, during an address period of performing selective discharge of the pixel, a voltage required for the selective discharge is applied to said one terminal by using the first and second switches, and, during a sustaining discharge period of performing sustaining discharge in the pixel selected in the address period, a voltage required for the sustaining discharge is applied to said one terminal by using the first and second switches.

22. The drive circuit according to claim 19, wherein, during an address period of performing selective discharge of the pixel, said one terminal of the capacitive loads is selectively controlled sequentially by pairs of the first and second switches, and, during a sustaining discharge period of performing sustaining discharge in the pixel selected in the address period, all or part of the first and second switches are controlled so as to be redundantly activated for a certain period.

23. The drive circuit according to claim 19, wherein a ground is connected to said the other terminal of the capacitive load.

24. The drive circuit according to claim 19, wherein a ground or a power supply of a constant voltage is selectively connected to said the other terminal of the capacitive load.
